(19) United States
(12) Patent Application Publication
(10) Pub. No.: US 2025/0048211 A1
(43) Pub. Date: Feb. 6, 2025

(54) ELECTRONIC DEVICE FOR SELECTIVELY OPERATING IN SHARED NETWORK OR SUBSCRIBER NETWORK BASED ON SERVICE TYPE IN SHARED NETWORK ENVIRONMENT AND OPERATING METHOD THEREOF

(71) Applicant: Samsung Electronics Co., Ltd., Suwon-si (KR)

(72) Inventors: Kyoungho LEE, Suwon-si (KR); Kipyo NAM, Suwon-si (KR)

(21) Appl. No.: 18/779,735

(22) Filed: Jul. 22, 2024

Related U.S. Application Data
(63) Continuation of application No. PCT/KR2024/006878, filed on May 21, 2024.

(30) Foreign Application Priority Data
Aug. 4, 2023 (KR) 10-2023-0102075
Aug. 25, 2023 (KR) 10-2023-0111998

(51) Int. Cl. H04W 36/08; H04W 8/18; H04W 36/00; H04W 48/18

(52) U.S. Cl. CPC H04W 36/08; H04W 8/18; H04W 36/0061; H04W 48/18

(57) ABSTRACT

An electronic device is provided. The electronic device in an embodiment includes a subscriber identity module (SIM) and at least one processor, comprising processing circuitry, electrically connected to the SIM. At least one processor, individually and/or collectively, is configured to: detect a second cell based on a movement of the electronic device in a first cell of a network of a telecommunications carrier of the SIM, recognize a 5G shared network based on at least a portion of system information of the second cell, determine whether the electronic device requires a 5G service in the 5G shared network, based on determining that the electronic device requires a service other than the 5G service, control the electronic device to be connected to a base station of the first cell, and based on determining that the electronic device requires the 5G service, control the electronic device to be connected to a base station of the 5G shared network.

### CROSS-REFERENCE TO RELATED APPLICATIONS

This application is a continuation application of International Application No. PCT/KR2024/006878 designating the United States, filed on May 21, 2024, in the Korean Intellectual Property Receiving Office and claiming priority to Korean Patent Application No. 10-2023-0102075, filed on Aug. 4, 2023, and Korean Patent Application No. 10-2023-0111998, filed on Aug. 25, 2023, in the Korean Intellectual Property Office, the disclosures of each of which are incorporated by reference herein in their entireties.

### BACKGROUND

### 1. Field

The disclosure relates to an electronic device that selectively operates in a shared network or a subscriber network based on a service type in a shared network environment and an operating method thereof.

### 2. Description of Related Art

The number of 5G subscribers may be relatively great in cities, and the number of 5G subscribers may be relatively small in rural areas. A service gap may occur between a 5G service in a city and a 5G service in a rural area. To address the service gap, a 5G shared network in which one telecommunications carrier establishes a 5G base station (or a 5G network) in a rural area and the other telecommunications carriers are shared with the established 5G base station (or the 5G network) may be used.

In an area where a subscription telecommunications carrier network of an electronic device and a 5G shared network coexist, mobility management entities (MMEs) and/or tracking area identities (TAIs) of the subscription telecommunications carrier network and the 5G shared network may be different from each other. Accordingly, tracking area update (TAU) may be performed for each cell reselection or handover, and this may increase the number of signaling times. In addition, a case in which TAU is rejected according to an MME in the 5G shared network or a case in which there is no TAU response may frequently occur. In this case, the number of signaling times, such as an attach procedure of an electronic device, may increase. In addition, when an electronic device enters the 5G shared network from the subscription telecommunications carrier network, a ping-pong handover may occur between the subscription telecommunications carrier network and the 5G shared network.

### SUMMARY

Embodiments of the disclosure may provide an electronic device that may reduce the number of signaling times by restricting cell reselection and handover in the 5G shared network.

Embodiments of the disclosure may provide an electronic device that may return to a subscription telecommunications carrier network and camp on the subscription telecommunications carrier network when a non-default data subscription (DDS) subscriber identity module (SIM) is used in the 5G shared network.

An electronic device according to an example embodiment includes: a SIM and at least one processor, comprising processing circuitry. At least one processor, individually and/or collectively, is configured to: detect a second cell based on a movement of the electronic device in a first cell of a network of a telecommunications carrier of the SIM; recognize a 5G shared network based on at least a portion of system information of the second cell; determine whether the electronic device requires a 5G service in the 5G shared network; based on determining that the electronic device requires a service other than the 5G service, control the electronic device to be connected to a base station of the first cell; and based on determining that the electronic device requires the 5G service, control the electronic device to be connected to a base station of the 5G shared network.

According to an example embodiment, an electronic device includes: a plurality of SIMs and at least one processor, comprising processing circuitry, electrically connected to each of the plurality of SIMs, wherein at least one processor, individually and/or collectively, is configured to: detect a second cell through one of the plurality of SIMs based on a movement of the electronic device in a first cell; recognize a 5G shared network based on at least a portion of system information of the second cell; determine whether the electronic device requires a 5G service in the 5G shared network; based on determining that the electronic device requires the service other than the 5G service, control the electronic device to connect to a base station of the first cell; and based on determining that the electronic device requires the 5G service, control the electronic device to connect to a base station of the 5G shared network.

### BRIEF DESCRIPTION OF THE DRAWINGS

The above and other aspects, features, and advantages of certain embodiments of the present disclosure will be more apparent from the following detailed description, taken in conjunction with the accompanying drawings, in which:

FIG. 1 is a block diagram illustrating an example electronic device in a network environment, according to various embodiments;

FIG. 2 is a block diagram illustrating an example configuration of an electronic device in a network environment including a plurality of cellular networks according to various embodiments;

FIG. 3 is a diagram illustrating an example of a 5G shared network according to various embodiments;

FIG. 4A is a block diagram illustrating an example configuration of an electronic device according to various embodiments;

FIG. 4B is a block diagram illustrating an example configuration of an electronic device according to various embodiments;

FIG. 5 is a flowchart illustrating an example method of operating an electronic device according to various embodiments;

FIGS. 6, 7 and 8 include a diagram and flowcharts illustrating example operation of an electronic device in new radio (NR) standalone (SA) according to various embodiments;

FIGS. 9, 10, 11A and 11B includes a diagram and flowcharts illustrating example operation of an electronic device in NR non-standalone (NSA) according to various embodiments;

FIG. 12 is a flowchart illustrating an example operation of an electronic device when the electronic device receives an evolved packet system (EPS) mobility management (EMM) message in a 5G shared network according to various embodiments; and

FIG. 13 is a flowchart illustrating an example method of operating an electronic device according to various embodiments.

### DETAILED DESCRIPTION

Hereinafter, various example embodiments will be described in greater detail with reference to the accompanying drawings. When describing the various example embodiments with reference to the accompanying drawings, like reference numerals refer to like components, and any repeated description related thereto may be omitted.

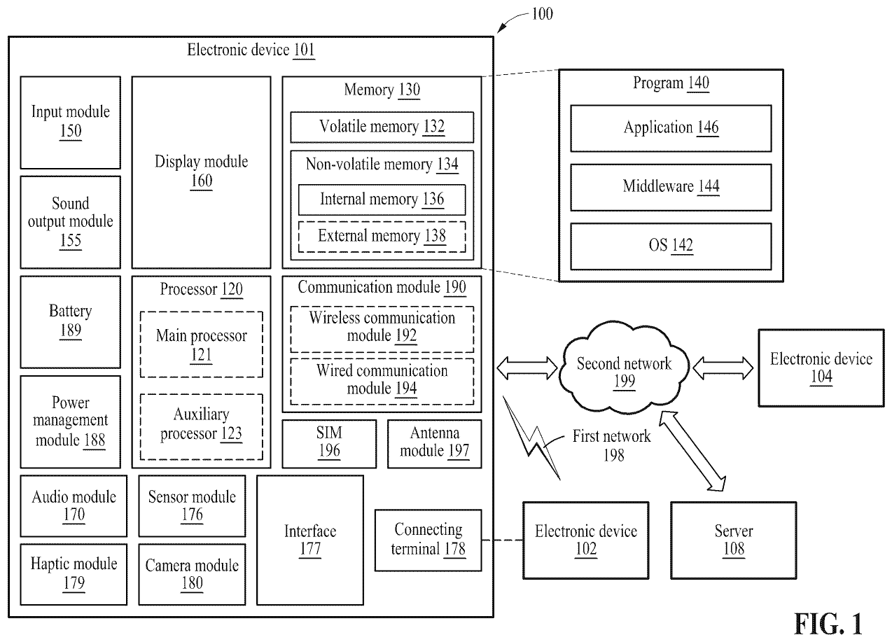

FIG. 1 is a block diagram illustrating an example electronic device 101 in a network environment 100 according to various embodiments. Referring to FIG. 1, the electronic device 101 in the network environment 100 may communicate with an electronic device 102 via a first network 198 (e.g., a short-range wireless communication network), or communicate with at least one of an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, a memory 130, an input module 150, a sound output module 155, a display module 160, an audio module 170, and a sensor module 176, an interface 177, a connecting terminal 178, a haptic module 179, a camera module 180, a power management module 188, a battery 189, a communication module 190, a subscriber identification module (SIM) 196, or an antenna module 197. In various embodiments, at least one (e.g., the connecting terminal 178) of the above components may be omitted from the electronic device 101, or one or more other components may be added in the electronic device 101. In various embodiments, some (e.g., the sensor module 176, the camera module 180, or the antenna module 197) of the components may be integrated as a single component (e.g., the display module 160).

The processor 120 may include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions. The processor 120 may execute, for example, software (e.g., a program 140) to control at least one other component (e.g., a hardware or software component) of the electronic device 101 connected to the processor 120, and may perform various data processing or computation. According to an embodiment, as at least a portion of data processing or computation, the processor 120 may store a command or data received from another component (e.g., the sensor module 176 or the communication module 190) in a volatile memory 132, process the command or the data stored in the volatile memory 132, and store resulting data in a non-volatile memory 134. According to an embodiment, the processor 120 may include a main processor 121 (e.g., a central processing unit (CPU) or an application processor (AP)) or an auxiliary processor 123 (e.g., a graphics processing unit (GPU), a neural processing unit (NPU), an image signal processor (ISP), a sensor hub processor, or a communication processor (CP)) that is operable independently of, or in conjunction with the main processor 121. For example, when the electronic device 101 includes the main processor 121 and the auxiliary processor 123, the auxiliary processor 123 may be adapted to consume less power than the main processor 121 or to be specific to a specified function. The auxiliary processor 123 may be implemented separately from the main processor 121 or as a part of the main processor 121.

The auxiliary processor 123 may control at least some of functions or states related to at least one (e.g., the display module 160, the sensor module 176, or the communication module 190) of the components of the electronic device 101, instead of the main processor 121 while the main processor 121 is in an inactive (e.g., sleep) state or along with the main processor 121 while the main processor 121 is in an active state (e.g., executing an application). According to an embodiment, the auxiliary processor 123 (e.g., an ISP or a CP) may be implemented as a portion of another component (e.g., the camera module 180 or the communication module 190) that is functionally related to the auxiliary processor 123. According to an embodiment, the auxiliary processor 123 (e.g., an NPU) may include a hardware structure specified for artificial intelligence (AI) model processing. An AI model may be generated by machine learning. Such learning may be performed by, for example, the electronic device 101 in which artificial intelligence is performed, or performed via a separate server (e.g., the server 108). Learning algorithms may include, but are not limited to, for example, supervised learning, unsupervised learning, semi-supervised learning, or reinforcement learning. The AI model may include a plurality of artificial neural network layers. An artificial neural network may include, for example, a deep neural network (DNN), a convolutional neural network (CNN), a recurrent neural network (RNN), a restricted Boltzmann machine (RBM), a deep belief network (DBN), a bidirectional recurrent deep neural network (BRDNN), a deep Q-network, or a combination of two or more thereof, but is not limited thereto. The AI model may additionally or alternatively include a software structure other than the hardware structure.

The memory 130 may store various data used by at least one component (e.g., the processor 120 or the sensor module 176) of the electronic device 101. The various pieces of data may include, for example, software (e.g., the program 140) and input data or output data for a command related thereto. The memory 130 may include the volatile memory 132 or the non-volatile memory 134.

The program 140 may be stored as software in the memory 130 and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output a sound signal to the outside of the electronic device 101. The sound output module 155 may include, for example, a speaker or a receiver. The speaker may be used for general purposes, such as playing multimedia or playing record. The receiver may be used to receive an incoming call. According to an embodiment, the receiver may be implemented separately from the speaker or as a portion of the speaker.

The display module 160 may visually provide information to the outside (e.g., a user) of the electronic device 101. The display module 160 may include, for example, a control circuit for controlling a display, a hologram device, or a projector and control circuitry to control a corresponding one of the display, the hologram device, and the projector. According to an embodiment, the display module 160 may include a touch sensor adapted to sense a touch, or a pressure sensor adapted to measure an intensity of a force incurred by the touch. The display module 160 may be implemented with, for example, a foldable structure and/or a rollable structure. For example, a size of a display screen of the display module 160 may be reduced when folded and expanded when unfolded.

The audio module 170 may convert a sound into an electrical signal or vice versa. According to an embodiment, the audio module 170 may obtain the sound via the input module 150 or output the sound via the sound output module 155 or an external electronic device (e.g., an electronic device 102 such as a speaker or a headphone) directly or wirelessly connected to the electronic device 101.

The sensor module 176 may detect an operational state (e.g., power or temperature) of the electronic device 101 or an environmental state (e.g., a state of a user) external to the electronic device 101, and generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., by wire) or wirelessly. According to an embodiment, the interface 177 may include, for example, a high-definition multimedia interface (HDMI), a universal serial bus (USB) interface, a secure digital (SD) card interface, or an audio interface.

The connecting terminal 178 may include a connector via which the electronic device 101 may be physically connected to an external electronic device (e.g., the electronic device 102). According to an embodiment, the connecting terminal 178 may include, for example, an HDMI connector, a USB connector, an SD card connector, or an audio connector (e.g., a headphone connector).

The haptic module 179 may convert an electrical signal into a mechanical stimulus (e.g., a vibration or a movement) or an electrical stimulus which may be recognized by a user via his or her tactile sensation or kinesthetic sensation. According to an embodiment, the haptic module 179 may include, for example, a motor, a piezoelectric element, or an electric stimulator.

The camera module 180 may capture a still image and moving images. According to an embodiment, the camera module 180 may include one or more lenses, image sensors, ISPs, or flashes.

The power management module 188 may manage power supplied to the electronic device 101. According to an embodiment, the power management module 188 may be implemented as, for example, at least a portion of a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently of the processor 120 (e.g., an AP) and that support a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module, or a power line communication (PLC) module). A corresponding one of these communication modules may communicate with the external electronic device 104 via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a 5G network, a next-generation communication network, the Internet, or a computer network (e.g., a LAN or a wide area network (WAN))). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the SIM 196.

The wireless communication module 192 may support a 5G network after a 4G network, and a next-generation communication technology, e.g., a new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., a mmWave band) to achieve, e.g., a high data transmission rate. The wireless communication module 192 may support various technologies for securing performance on a high-frequency band, such as, e.g., beamforming, massive multiple-input and multiple-output (MIMO), full dimensional MIMO (FD-MIMO), an array antenna, analog beam-forming, or a large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device) of the electronic device 101. According to an embodiment, the antenna module 197 may include an antenna including a radiating element including a conductive material or a conductive pattern formed in or on a substrate (e.g., a printed circuit board (PCB)). According to an embodiment, the antenna module 197 may include a plurality of antennas (e.g., array antennas). In such a case, at least one antenna appropriate for a communication scheme used in a communication network, such as the first network 198 or the second network 199, may be selected by, for example, the communication module 190 from the plurality of antennas. The signal or power may be transmitted or received between the communication module 190 and the external electronic device via the at least one selected antenna. According to an embodiment, another component (e.g., a radio frequency integrated circuit (RFIC)) other than the radiating element may be additionally formed as a part of the antenna module 197.

According to an embodiment, the antenna module 197 may form a mmWave antenna module. According to an embodiment, the mmWave antenna module may include a PCB, an RFIC disposed on a first surface (e.g., a bottom surface) of the PCB or adjacent to the first surface and capable of supporting a designated a high-frequency band (e.g., the mmWave band), and a plurality of antennas (e.g., array antennas) disposed on a second surface (e.g., a top or a side surface) of the PCB, or adjacent to the second surface and capable of transmitting or receiving signals in the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the external electronic devices 102 and 104 may be a device of the same type as or a different type from the electronic device 101. According to an embodiment, all or some of operations to be executed by the electronic device 101 may be executed at one or more of the external electronic devices 102, 104, and 108. For example, if the electronic device 101 needs to perform a function or a service automatically, or in response to a request from a user or another device, the electronic device 101, instead of, or in addition to, executing the function or the service, may request one or more external electronic devices to perform at least part of the function or the service. The one or more external electronic devices receiving the request may perform the at least part of the function or the service requested, or an additional function or an additional service related to the request, and may transfer an outcome of the performing to the electronic device 101. The electronic device 101 may provide the result, with or without further processing the result, as at least part of a response to the request. To this end, cloud computing, distributed computing, mobile edge computing (MEC), or client-server computing technology may be used, for example. The electronic device 101 may provide ultra low-latency services using, e.g., distributed computing or mobile edge computing. In an embodiment, the external electronic device 104 may include an Internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., a smart home, a smart city, a smart car, or healthcare) based on 5G communication technology or IoT-related technology.

The electronic device according to various embodiments may be one of various types of electronic devices. The electronic device may include, for example, a portable communication device (e.g., a smartphone), a computer device, a portable multimedia device, a portable medical device, a camera, a wearable device, a home appliance device, or the like. According to an embodiment of the disclosure, the electronic device is not limited to those described above.

It should be appreciated that embodiments of the disclosure and the terms used therein are not intended to limit the technological features set forth herein to particular embodiments and include various changes, equivalents, or replacements for a corresponding embodiment. In connection with the description of the drawings, like reference numerals may be used for similar or related components. It is to be understood that a singular form of a noun corresponding to an item may include one or more of the things, unless the relevant context clearly indicates otherwise. As used herein, “A or B”, “at least one of A and B”, “at least one of A or B”, “A, B or C”, “at least one of A, B and C”, and “A, B, or C,” each of which may include any one of the items listed together in the corresponding one of the phrases, or all possible combinations thereof. Terms such as “first”, “second”, or “first” or “second” may simply be used to distinguish the component from other components in question, and may refer to components in other aspects (e.g., importance or order) is not limited. It is to be understood that if an element (e.g., a first element) is referred to, with or without the term “operatively” or “communicatively”, as “coupled with,” “coupled to,” “connected with,” or “connected to” another element (e.g., a second element), the element may be coupled with the other element directly (e.g., wiredly), wirelessly, or via a third element.

As used in connection with embodiments of the disclosure, the term “module” may include a unit implemented in hardware, software, or firmware, or any combination thereof, and may interchangeably be used with other terms, for example, “logic,” “logic block,” “part,” or “circuitry.” A module may be a single integral component, or a minimum unit or part thereof, adapted to perform one or more functions. For example, according to an embodiment, the module may be implemented in a form of an application-specific integrated circuit (ASIC).

Embodiments as set forth herein may be implemented as software (e.g., the program 140) including one or more instructions that are stored in a storage medium (e.g., an internal memory 136 or an external memory 138) that is readable by a machine (e.g., the electronic device 101 of FIG. 1). For example, a processor (e.g., the processor 120) of the machine (e.g., the electronic device 101) may invoke at least one of the one or more instructions stored in the storage medium, and execute it. This allows the machine to be operated to perform at least one function according to the at least one instruction invoked. The one or more instructions may include code generated by a compiler or code executable by an interpreter. The machine-readable storage medium may be provided in the form of a non-transitory storage medium. Here, the “non-transitory” storage medium is a tangible device, and may not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read-only memory (CD-ROM)), or be distributed (e.g., downloaded or uploaded) online via an application store (e.g., PlayStore™), or between two user devices (e.g., smartphones) directly. If distributed online, at least portion of the computer program product may be temporarily generated or at least temporarily stored in the machine-readable storage medium, such as memory of the manufacturer's server, a server of the application store, or a relay server.

According to an embodiment, each component (e.g., a module or a program) of the above-described components may include a single entity or multiple entities, and some of the multiple entities may be separately disposed in different components. According to various embodiments, one or more of the above-described components or operations may be omitted, or one or more other components or operations may be added. Alternatively or additionally, a plurality of components (e.g., modules or programs) may be integrated into a single component. In such a case, according to embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

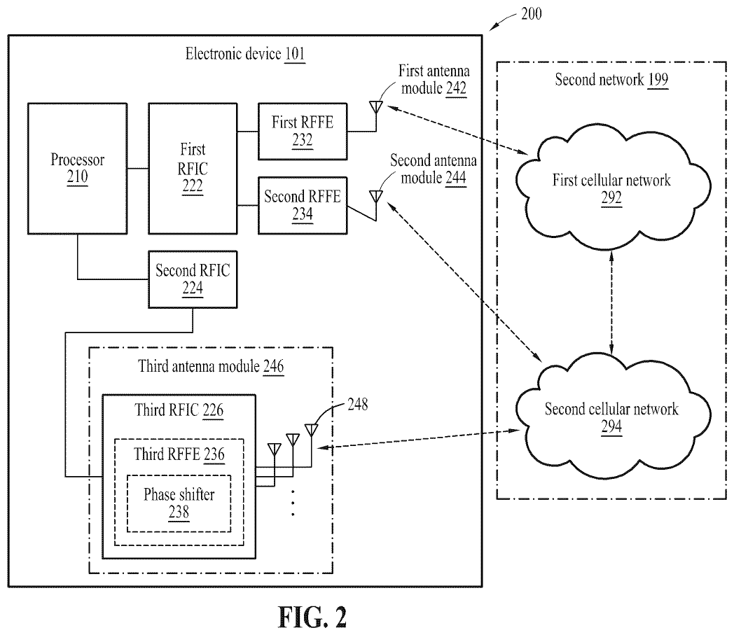

FIG. 2 is a block diagram illustrating an example configuration of an electronic device 101 in a network environment 200 including a plurality of cellular networks according to various embodiments.

Referring to FIG. 2, the electronic device 101 may include a processor (e.g., including processing circuitry) 210 (e.g., the processor 120 of FIG. 1), a first radio frequency integrated circuit (RFIC) 222, a second RFIC 224, a first radio frequency front end (RFFE) 232, a second RFFE 234, a first antenna module (e.g., including an antenna) 242, a second antenna module (e.g., including an antenna) 244, and a third antenna module (e.g., including an antenna) 246. The second network 199 may include a first cellular network 292 (e.g., a legacy network) and a second cellular network 294 (e.g., a 5G network). The electronic device 101 may further include at least one of the components described with reference to FIG. 1, and the second network 199 may further include at least one other network. According to an embodiment, the second RFIC 224 may be omitted or may be included as a part of the third RFIC 226.

According to an embodiment, the first RFIC 222, the second RFIC 224, the first RFFE 232, and the second RFFE 234 of FIG. 2 may be included in the communication module 190 (e.g., the wireless communication module 192) of FIG. 1 and the first antenna module 242, the second antenna module 244, and the third antenna module 246 of FIG. 2 may be included in the antenna module 197 of FIG. 1.

According to an embodiment, the processor 210 (e.g., a communication processor) may include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions. The processor 210 may, for example, establish a communication channel in a band to be used for wireless communication with the first cellular network 292 and may support legacy network communication through the established communication channel. The first cellular network 292 may be, for example, a legacy network including a 2G, 3G, 4G, or long-term evolution (LTE) network. The processor 210 may establish a communication channel corresponding to a first band (e.g., approximately 6 GHz to 60 GHz) (or a 5G standard frequency range (FR) 2 (e.g., 24.25 GHz to 52.6 GHz) of bands to be used for wireless communication with the second cellular network 294 and may support 5G network communication through the established communication channel. The second cellular network 294 may be a 5G network defined by a third-generation partnership project (3GPP). The processor 210 may establish a communication channel corresponding to a second band (e.g., approximately less than or equal to 6 GHZ) (or a 5G standard FR1 (e.g., 410 MHz to 7.125 GHZ) of bands to be used for wireless communication with the second cellular network 294 and may support 5G network communication through the established communication channel.

According to an embodiment, the first RFIC 222 may convert a baseband signal generated by the processor 210 into a radio frequency (RF) signal of a frequency band (e.g., approximately 700 MHz to approximately 3 GHz) used by the first cellular network 292 in the case of transmission. In the case of reception, the RF signal may be received or obtained from the first cellular network 292 through the first antenna module 242 and may be preprocessed through the first RFFE 232. The first RFIC 222 may convert the preprocessed RF signal into a baseband signal to be processed by the processor 210.

According to an embodiment, the first RFIC 222 may convert the baseband signal generated by the processor 210 into an RF signal (hereinafter, referred to as a 5G Sub6 RF signal) in a Sub6 band (e.g., approximately less than or equal to 6 GHz) used by the second cellular network 294 in the case of transmission. In the case of reception, the 5G Sub6 RF signal may be received or obtained from the second cellular network 294 through the second antenna module 244 and may be preprocessed through the second RFFE 234. The first RFIC 222 may convert the preprocessed 5G Sub6 RF signal into a baseband signal to be processed by the processor 210.

According to an embodiment, the third RFIC 226 may convert a baseband signal generated by the processor 210 into an RF signal (hereinafter, referred to as a 5G Above6 RF signal) in a 5G Above6 band (e.g., approximately 6 GHz to approximately 60 GHz) to be used by the second cellular network 294. In the case of reception, the 5G Above6 RF signal may be received or obtained from the second cellular network 294 through the third antenna module 246 (e.g., an antenna 248) and may be preprocessed through the third RFFE 236. The third RFIC 226 may convert the preprocessed 5G Above6 RF signal into a baseband signal to be processed by the processor 210. According to an embodiment, the third RFFE 236 may be formed as a part of the third RFIC 226.

According to an embodiment, the electronic device 101 may include the second RFIC 224 separately from or as a part of the third RFIC 226. In this case, the second RFIC 224 may convert the baseband signal generated by the processor 210 into an RF signal (hereinafter referred to as an IF signal) of an intermediate frequency band (e.g., approximately 9 GHz to 11 GHz) and may transmit the IF signal to the third RFIC 226. The third RFIC 226 may convert the IF signal into the 5G Above6 RF signal. In the case of reception, the 5G Above6 RF signal may be received or obtained from the second cellular network 294 through the third antenna module 246 (e.g., the antenna 248) and may be converted into an IF signal by the third RFIC 226. The second RFIC 224 may convert the IF signal into a baseband signal such that the processor 210 may process the IF signal.

According to an embodiment, at least one of the first antenna module 242 and the second antenna module 244 may be omitted or may be combined with another antenna module to process RF signals in a plurality of corresponding bands.

According to an embodiment, the third RFIC 226 and the antenna 248 may be disposed on the same substrate and may form the third antenna module 246. For example, the processor 120 may be disposed on a first substrate (e.g., a main PCB). In this case, as the third RFIC 226 is disposed on a partial area (e.g., a bottom surface) of a second substrate (e.g., a sub PCB) separate from the first substrate and the antenna 248 is disposed on the other partial area (e.g., a top surface) of the second substrate (e.g., the sub PCB), the third antenna module 246 may be formed. The length of a transmission line between the third RFIC 226 and the antenna 248 may be reduced by disposing the third RFIC 226 and the antenna 248 on the same substrate. This may reduce, for example, the loss (e.g., attenuation) of a signal in a high-frequency band (e.g., approximately 6 GHz to 60 GHz) used for 5G network communication due to a transmission line. Because of this, the electronic device 101 may improve the quality or speed of communication with the second cellular network 294 (e.g., a 5G network).

According to an embodiment, the antenna 248 may be formed of an antenna array including a plurality of antenna elements used for beamforming. In this case, the third RFIC 226 may include, for example, a plurality of phase shifters 238 corresponding to the plurality of antenna elements as a part of the third RFFE 236. In the case of transmission, the plurality of phase shifters 238 may convert a phase of a 5G Above6 RF signal to be transmitted to the outside (e.g., a base station of the 5G network) of the electronic device 101 through corresponding antenna elements. In the case of reception, the plurality of phase shifters 238 may convert a phase of a 5G Above6 RF signal received from the outside (e.g., the base station of the 5G network) through the corresponding antenna elements into the same or substantially the same phase. This may enable transmission or reception through beamforming between the electronic device 101 and the outside.

The second cellular network 294 may be operated independently (e.g., standalone (SA)) of the first cellular network 292 or integrally (e.g., non-standalone (NSA)). For example, a 5G network may include only an access network (e.g., a 5G radio access network (RAN) or a next-generation RAN (NG RAN)) and may not include a core network (e.g., a next-generation core (NGC)). In this case, after the electronic device 101 accesses the access network of the 5G network, the electronic device 101 may access an external network (e.g., the Internet) under the control of a core network (e.g., an evolved packet core (EPC)) of a legacy network. Protocol information (e.g., LTE protocol information) for communication with the legacy network or protocol information (e.g., new radio (NR) protocol information) for communication with the 5G network may be stored in a memory (e.g., the memory 130 of FIG. 1) and may be accessed by the processor 210.

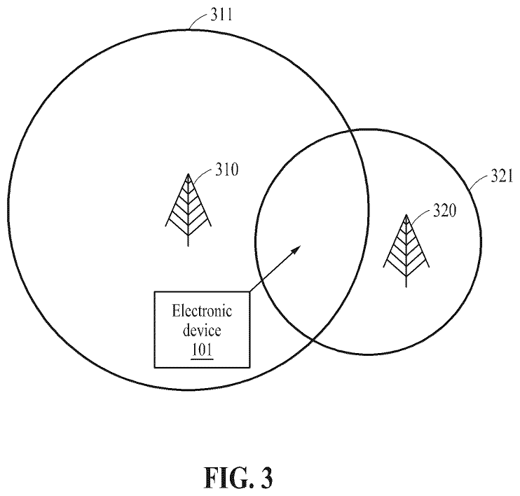

FIG. 3 is a diagram illustrating an example of a 5G shared network according to various embodiments.

Referring to FIG. 3, the electronic device 101 may support 5G. The electronic device 101 may move from a first cell (or a service area of a base station 310) 311 and may enter a 5G shared network cell (or a 5G shared network service area) 321.

According to an embodiment, the electronic device 101 may include a single subscriber identity module (SIM) (e.g., the SIM 196 of FIG. 1). For example, the first cell 311 may correspond to a cell (e.g., an LTE cell) of a telecommunications carrier network of the SIM of the electronic device 101.

According to an embodiment, the electronic device 101 may include a plurality of SIMs (e.g., a default data subscription (DDS) SIM and a non-DDS SIM). A telecommunications carrier of the DDS SIM and a telecommunications carrier of the non-DDS SIM may be different or the same. The first cell 311 may correspond to, for example, a cell (e.g., an LTE cell) of the carrier network of the DDS SIM or the carrier network of the non-DDS SIM.

According to an embodiment, the 5G shared network may represent, for example, a 5G network shared with a plurality of telecommunications carriers. Core networks of the plurality of telecommunications carriers may share a base station (e.g., a 5G base station) 320 of the 5G shared network cell 321 (e.g., in a manner of multi-operator core network (MOCN)). The 5G shared network cell 321 of FIG. 3 may be established by a telecommunications carrier other than a subscription telecommunications carrier (e.g., the telecommunications carrier of the SIM of the electronic device 101 or the telecommunications carrier of the DDS SIM of the electronic device 101). Even if the 5G shared network cell 321 is not established by the subscription telecommunications carrier, the electronic device 101 may be provided with a 5G service (e.g., packet data communication and voice over new radio (VoNR)) from the 5G shared network cell 321.

According to an embodiment, the 5G shared network (or the 5G shared network cell 321) may be based on NR NSA. In NR NSA, the base station 320 of the 5G shared network cell 321 may correspond to a secondary base station and an LTE base station connected to the base station 320 of the 5G shared network cell 321 may correspond to a master base station. The electronic device 101 may receive system information (e.g., a master information block (MIB), a system information block (SIB) 1, and an SIB 2) from an LTE base station connected to the base station 320. The electronic device 101 may access an LTE base station connected to the base station 320 and may access the base station 320 of the 5G shared network cell 321 via the accessed LTE base station. The electronic device 101 may be provided with a 5G service from the 5G shared network cell 321 (or the base station 320).

According to an embodiment, the 5G shared network (or the 5G shared network cell 321) may be based on NR SA. In NR SA, the electronic device 101 may receive system information (e.g., the MIB, SIB 1, and SIB 2) from the base station 320 of the 5G shared network cell 321. The electronic device 101 may access the base station 320 and may be provided with the 5G service from the 5G shared network cell 321 (or the base station 320).

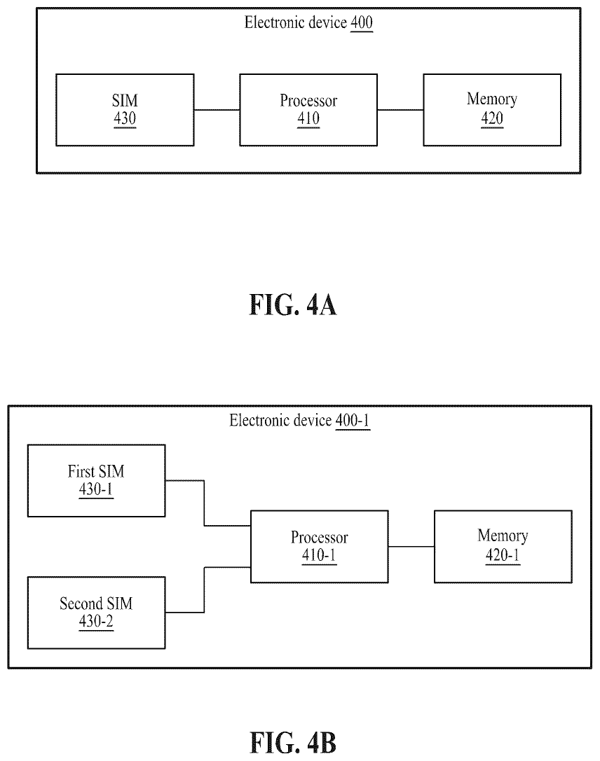

FIG. 4A is a block diagram illustrating an example configuration of an electronic device according to various embodiments.

Referring to FIG. 4A, an electronic device 400 (e.g., the electronic device 101 of FIGS. 1 to 3) in an embodiment may include a processor (e.g., including processing circuitry) 410 (e.g., the processor 120 of FIG. 1 and the processor 210 of FIG. 2), a memory 420 (e.g., the memory 130 of FIG. 1), and a subscriber identification module (SIM) 430 (e.g., the SIM 196 of FIG. 1). The SIM 430 may correspond to a removable SIM (rSIM) that is removable or an embedded SIM (eSIM).

The processor 410 may be operatively connected to the memory 420 and may execute one or more instructions stored in the memory 420. The processor 410 may be electrically and/or operationally connected to the SIM 430. The processor 410 may include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions.

According to an embodiment, the processor 410 may detect a second cell from a first cell (e.g., the first cell 311 of FIG. 3). For example, when the electronic device 400 moves from the first cell 311, the processor 410 may detect the second cell. In another example, when the electronic device 400 is booted in an area where the first cell 311 overlaps with the second cell, the processor 410 may detect the second cell. In another example, the processor 410 may detect the second cell in a boundary area of the first cell 311. In various examples other than the examples described above, the processor 410 may detect the second cell. The processor 410 may further detect one or more other cells.

According to an embodiment, the processor 410 may receive system information (e.g., the MIB, SIB 1, and SIB 2) from a base station of the detected second cell. At least one public land mobile network (PLMN) identifier (ID) may be included in the received SIB 1.

According to an embodiment, when a plurality of PLMN IDs is included in the received SIB 1, the processor 410 may select a subscription telecommunications carrier network of the SIM 430 and may perform a network registration procedure (e.g., an attach procedure) using the SIM 430. For example, the processor 410 may transmit an attach request message including information about the selected subscription telecommunications carrier network to the base station of the detected second cell. The processor 410 may receive an attach accept message or an attach reject message from the base station of the detected second cell.

According to an embodiment, the processor 410 may recognize that a 5G shared network exists in an area where the electronic device 400 is located based on at least a portion of system information on the detected second cell and system information on the detected other cells. For example, in NR SA, the second cell may correspond to an NR SA cell, and the processor 410 may determine that the second cell supports the 5G shared network based on at least a portion of the system information on the detected second cell and the system information on the detected other cells. In another example, in NR NSA, the second cell may correspond to an LTE cell, and the processor 410 may determine that a 5G cell that forms dual connectivity with the second cell supports the 5G shared network based on at least a portion of the system information on the detected second cell and the system information on the detected other cells.

According to an embodiment, in a radio resource control (RRC) idle state, the electronic device 400 may camp on the second cell. In the RRC idle state, the processor 410 may restrict a cell reselection operation to maintain a camp-on state. For example, as described below, the processor 410 may block (or prohibit) the reselection of an inter-radio access technology (RAT) cell and may restrictively allow an inter-frequency cell reselection operation and/or an intra-frequency cell reselection operation.

According to an embodiment, in NR NSA (and/or in NR SA), an RRC state of the electronic device 400 may be changed from the RRC idle state to an RRC connected state. In NR NSA (and/or in NR SA), the processor 410 may determine (or select) whether to perform an operation according to a network configuration or whether to be operated in the 5G shared network cell depending on whether the electronic device 400 requires a 5G service. The 5G service may include, for example, a packet service of a 5G service category (e.g., enhanced mobile broadband (eMBB), massive machine-type communications (mMTC), and ultra-reliable and low latency communications (URLLC)). For example, when the electronic device 400 requires the 5G service, the processor 410 may access the base station of the 5G shared network cell. When the electronic device 400 does not require the 5G service, the processor 410 may access the base station of the first cell by performing an operation according to the network configuration.

According to an embodiment, in NR SA, the electronic device 400 and the 5G shared network cell may support VoNR. The 5G shared network cell may provide a voice call service in VoNR to the electronic device 400. When the electronic device 400 is provided with a voice call service of VoNR in the 5G shared network cell, the processor 410 may restrict a handover operation to allow the electronic device 400 to be in the 5G shared network cell.

According to an embodiment, in NR SA, the 5G shared network cell may not support VoNR. The 5G shared network cell may not provide a voice call service in VoNR to the electronic device 400. In this case, the 5G shared network cell may allow the electronic device 400 to access the first cell 311 by performing a fallback (e.g., an evolved packet system (EPS) fallback). The electronic device 400 may be provided with a voice call service in voice over LTE (VOLTE) from the first cell 311. When the electronic device 400 is provided with the voice call service of VOLTE from the first cell 311, the processor 410 may restrict a handover operation to allow the electronic device 400 to be in the first cell 311.

According to an embodiment, in the RRC connected state, the processor 410 may restrict a handover operation. As described below, the processor 410 may block (or prohibit) inter-RAT handover and may restrictively allow inter-handover and/or intra-handover.

According to an embodiment, when there is no data transmission or reception for a predetermined time period in the RRC connected state, the RRC state of the electronic device 400 may be changed from the RRC connected state to an RRC disabled state. In the RRC disabled state, the processor 410 may restrict a cell reselection operation. In the RRC disabled state, the processor 410 may block (or prohibit) the reselection of an inter-RAT cell and may restrictively allow an inter-frequency cell reselection operation and/or an intra-frequency cell reselection operation.

FIG. 4B is a block diagram illustrating an example configuration of an electronic device according to various embodiments.

Referring to FIG. 4B, an electronic device 400-1 (e.g., the electronic device 101 of FIGS. 1 to 3) in an embodiment may include a processor (e.g., including processing circuitry) 410-1, a memory 420-1, and a plurality of SIMs 430-1 and 430-2. In the example of FIG. 4B, the electronic device 400-1 includes two SIMs 430-1 and 430-2. However, this is only an example and the electronic device 400-1 may include three or more SIMs. The processor 410-1 may be operatively connected to the memory 420-1 and may execute one or more instructions stored in the memory 420-1. The processor 410-1 may be electrically and/or operationally connected to the plurality of SIMs 430-1 and 430-2. The processor 410-1 may include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions.

According to an embodiment, the electronic device 400-1 may operate in dual SIM dual standby (DSDS) or dual SIM dual active (DSDA).

According to an embodiment, a telecommunications carrier of the first SIM 430-1 and a telecommunications carrier of the second SIM 430-2 may be the same. The example is not limited thereto and the telecommunications carrier of the first SIM 430-1 and the telecommunications carrier of the second SIM 430-2 may be different from each other.

According to an embodiment, a portion (e.g., the first SIM 430-1) of the plurality of SIMs 430-1 and 430-2 may be a DDS SIM, and the other portion (e.g., the second SIM 430-2) of the plurality of SIMs 430-1 and 430-2 may be a non-DDS SIM. Some of the plurality of SIMs 430-1 and 430-2 may correspond to an rSIM and the other may correspond to an eSIM. Depending on the implementation, all of the plurality of SIMs 430-1 and 430-2 may correspond to eSIMs or rSIMs.

According to an embodiment, the processor 410-1 may detect a second cell from a first cell (e.g., the first cell 311 of FIG. 3). For example, when the electronic device 400-1 moves from the first cell 311, the processor 410-1 may detect the second cell. In this case, the processor 410-1 may further detect one or more other cells.

According to an embodiment, the processor 410-1 may receive system information (e.g., the MIB, SIB 1, and SIB 2) from a base station of the detected second cell. One or more PLMN IDs may be included in the received SIB 1.

According to an embodiment, when a plurality of PLMN IDs is included in the received SIB 1, the processor 410-1 may select a subscription telecommunications carrier network of a DDS SIM (e.g., the first SIM 430-1) or a subscription telecommunications carrier network of a non-DDS SIM (e.g., the second SIM 430-2) and may perform a network registration procedure (e.g., an attach procedure) using the DDS SIM or the non-DDS SIM. For example, the processor 410-1 may transmit an attach request message including information about the selected subscription telecommunications carrier network to a base station of a second cell. The processor 410 may receive an attach accept message or an attach reject message from the base station of the second cell.

According to an embodiment, the processor 410 may recognize that a 5G shared network exists in an area where the electronic device 400 is located based on at least a portion of system information on the detected second cell and system information on the detected other cells. For example, in NR SA, the second cell may correspond to an NR SA cell, and the processor 410 may determine that the second cell supports the 5G shared network based on at least a portion of the system information on the detected second cell and the system information on the detected other cells. In another example, in NR NSA, the second cell may correspond to an LTE cell, and the processor 410 may determine that a 5G cell that forms dual connectivity with the second cell supports the 5G shared network based on at least a portion of the system information on the detected second cell and the system information on the detected other cells.

According to an embodiment, when the non-DDS SIM is used (e.g., when performing a network registration procedure using the non-DDS SIM) in a 5G shared network area (e.g., an area of the second cell), the processor 410-1 may control the electronic device 400-1 to be operated in the first cell 311 rather than in the 5G shared network. Depending on the embodiment, the processor 410-1 may camp on the second cell through the non-DDS SIM. In this case, the processor 410-1 may cause the electronic device 400-1 to be operated in the first cell 311 rather than in the 5G shared network. When the DDS SIM is used (e.g., when performing the network registration procedure using the DDS SIM or camping on the second cell through the DDS SIM) in the 5G shared network area (e.g., the area of the second cell), the processor 410-1 may perform embodiments described below.

According to an embodiment, in the RRC idle state, the electronic device 400-1 may camp on the second cell. In the RRC idle state, the processor 410-1 may restrict a cell reselection operation to maintain a camp-on state. For example, the processor 410-1 may block (or prohibit) the reselection of an inter-RAT cell and may restrictively allow an inter-frequency cell reselection operation and/or an intra-frequency cell reselection operation.

According to an embodiment, in NR NSA (and/or in NR SA), an RRC state of the electronic device 400-1 may be changed from the RRC idle state to an RRC connected state. In NR NSA (and/or in NR SA), the processor 410-1 may determine (or select) whether to perform an operation according to a network configuration or whether to be operated in the 5G shared network cell depending on whether the electronic device 400-1 requires a 5G service. For example, when the electronic device 400-1 requires the 5G service, the processor 410-1 may access the base station of the 5G shared network cell. When the electronic device 400-1 does not require the 5G service, the processor 410-1 may access the base station 310 of the first cell 311 by performing an operation according to the network configuration.

According to an embodiment, in NR SA, the electronic device 400-1 and the 5G shared network cell may support VoNR. The 5G shared network cell may provide a voice call service in VoNR to the electronic device 400-1. When the electronic device 400-1 is provided with a voice call service of VoNR in the 5G shared network cell, the processor 410-1 may restrict a handover operation to allow the electronic device 400-1 to be in the 5G shared network cell.

According to an embodiment, in NR SA, the 5G shared network cell may not support VoNR. The 5G shared network cell may not provide a voice call service in VoNR to the electronic device 400-1. In this case, the 5G shared network cell may allow the electronic device 400-1 to access the first cell 311 by performing a fallback (e.g., an EPS fallback). The electronic device 400-1 may be provided with a voice call service in VOLTE from the first cell 311. When the electronic device 400-1 is provided with the voice call service of VOLTE from the first cell 311, the processor 410-1 may restrict a handover operation to allow the electronic device 400-1 to be in the first cell 311.

According to an embodiment, the RRC state of the electronic device 400-1 may be changed from the RRC connected state to an RRC disabled state. In the RRC disabled state, the processor 410-1 may restrict a cell reselection operation.

According to an embodiment, the electronic device 400 or 400-1 may provide a graphical user interface (GUI) in which a user may set (or select) a network mode (e.g., a 5G priority mode or an LTE priority mode). For example, the 5G priority mode may be a mode for preferentially connecting to a 5G network among networks that the electronic device 400 or 400-1 may support. For example, the LTE priority mode may be a mode for preferentially connecting to an LTE network among networks that the electronic device 400 or 400-1 may support. The electronic device 400 or 400-1 may set a network mode based on a selection input of the user. When the user selects the LTE priority mode, the electronic device 400 or 400-1 may set the network mode to the LTE priority mode. When the network mode is set to the LTE priority mode, the electronic device 400 or 400-1 may camp on and connect to the first cell 311 even if the electronic device 400 or 400-1 is located in the 5G shared network area.

According to an embodiment, the electronic device 400 or 400-1 may support 5G but a price plan may be an LTE plan. The electronic device 400 or 400-1 may receive a message that the 5G service is not available (e.g., an attach accept message in which restrictDCNR is set to true, a tracking area update (TAU) accept message in which restrictDCNR is set to true, or a TAU reject message) even if the electronic device 400 or 400-1 is located in the 5G shared network area. In this case, the electronic device 400 or 400-1 may camp on and connect to the first cell 311.

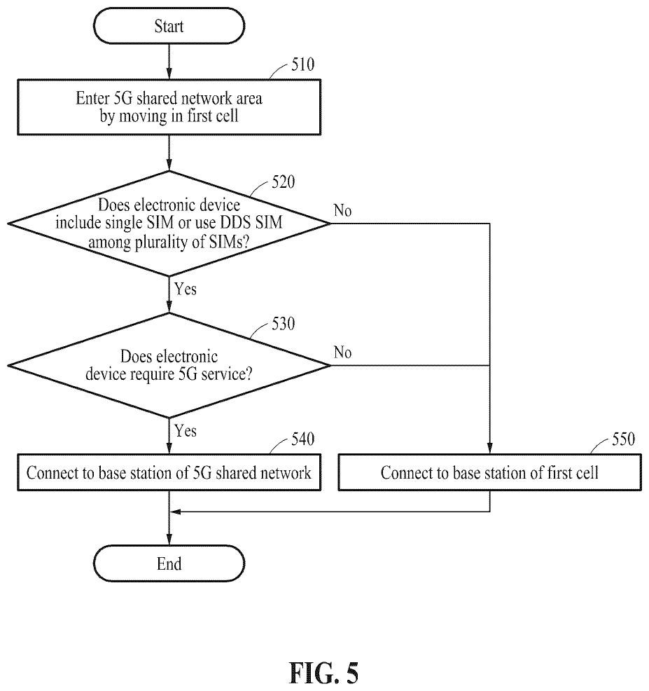

FIG. 5 is a flowchart illustrating an example method of operating an electronic device according to various embodiments.

Referring to FIG. 5, in operation 510, an electronic device (e.g., the electronic device 101 of FIGS. 1 to 3, the electronic device 400 of FIG. 4A, and the electronic device 400-1 of FIG. 4B) may enter (or be located in) a 5G shared network area (e.g., the 5G shared network cell 321 of FIG. 3) through the movement in a first cell (e.g., the first cell 311 of FIG. 3). The example is not limited thereto, and the electronic device may be located in the 5G shared network area when the electronic device is booted (or is turned on) in the 5G shared network area. The electronic device may be located in an area where the first cell and the 5G shared network area overlap with each other.

In operation 520, the electronic device (e.g., the processor 410 or 410-1) may check whether the electronic device includes a single SIM (e.g., the SIM 430 of FIG. 4A) or a plurality of SIMs (e.g., the SIMS 430-1 and 430-2 of FIG. 4B) and when the electronic device includes the plurality of SIMs, the electronic device may check whether a DDS SIM is used.

When the electronic device (e.g., the processor 410 or 410-1) checks that the DDS SIM among the plurality of SIMs is not used in the 5G shared network area (or when the electronic device checks that the non-DDS SIM among the plurality of SIMs is used) (operation 520—No), in operation 550, the electronic device may connect to (or access) the base station 310 of the first cell 311.

When the electronic device (e.g., the processor 410 or 410-1) includes a single SIM (e.g., the SIM 430 of FIG. 4A) or the DDS SIM is used among the plurality of SIMs 430-1 and 430-2 (operation 520—Yes), the electronic device may determine whether the electronic device requires the 5G service. For example, when data (e.g., packet data) to be transmitted to the electronic device or data (e.g., packet data of a 5G service category) to be transmitted by the electronic device exists, the processor 410 may determine that the electronic device requires the 5G service.

When the electronic device (e.g., the processor 410 or 410-1) determines that the electronic device requires the 5G service (operation 530—Yes), in operation 540, the electronic device may connect to (or access) the base station of the 5G shared network. The processor 410 or 410-1 may control the electronic device to connect to (or access) the base station of the 5G shared network. The electronic device may receive the data (e.g., the packet data of the 5G service category) from the base station of the 5G shared network or may transmit the data (e.g., the packet data of the 5G service category) to the base station of the 5G shared network. The electronic device may be provided with the 5G service.

When the electronic device (e.g., the processor 410 or 410-1) determines that the electronic device is in a state in which the 5G service is not required (or the electronic device does not require the 5G service) (operation 530—No), in operation 550, the electronic device may connect to (or access) the base station 310 of the first cell 311. The processor 410 or 410-1 may control the electronic device to connect to (or access) the base station 310 of the first cell 311.

According to an embodiment, in NR SA, the electronic device may support VoNR. The electronic device may be provided with the voice call service in VoNR from the 5G shared network depending on whether the 5G network supports VoNR or may be provided with the voice call service in VOLTE from the first cell 311. When the 5G shared network supports VoNR, the electronic device may be provided with the voice call service in VoNR from the 5G shared network. When the 5G shared network does not support VONR, the 5G shared network may cause the electronic device to access the first cell 311 through an EPS fallback. The electronic device may be provided with the voice call service in VOLTE from the first cell 311.

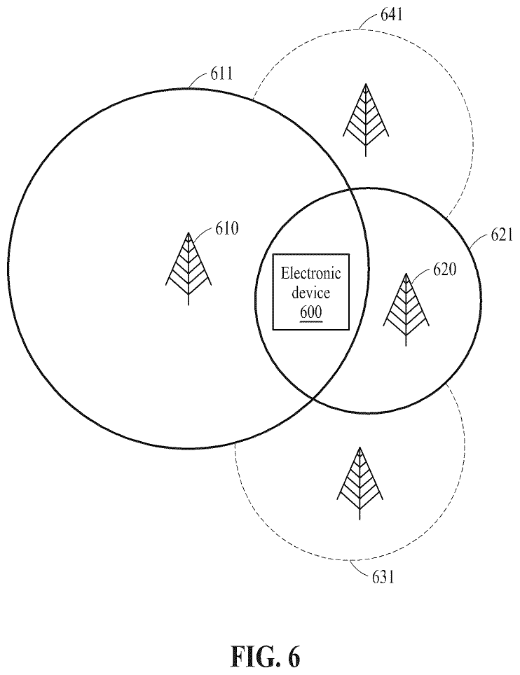

FIGS. 6, 7 and 8 include a diagram and flowcharts illustrating an example operation of an electronic device in new radio (NR) standalone (SA) according to various embodiments. In the example shown in FIG. 6, an electronic device 600 (e.g., the electronic device 101 of FIGS. 1 to 3, the electronic device 400 of FIG. 4A, and the electronic device 400-1 of FIG. 4B) may detect multiple cells (e.g., at least one LTE cell and/or at least one NR SA cell) through frequency scanning or frequency-based network search. For example, the electronic device 600 may detect a first cell 611 (e.g., the first cell 311 of FIG. 3), an NR SA cell 621, and LTE cells 631 and 641.

According to an embodiment, the electronic device 600 may detect multiple cells (e.g., at least one LTE cell and/or at least one NR SA cell) in various circumstances. For example, when the electronic device 600 moves from the first cell 611 to the NR SA cell 621, the electronic device 600 may detect the NR SA cell 621. In this case, the electronic device 600 may further detect at least one or all of the LTE cells 631 and 641. In another example, when the electronic device 600 is booted (or is turned on) in an area where the first cell 611 overlaps the NR SA cell 621, the electronic device 600 may detect at least one or all of the NR SA cell 621, the LTE cell 631, or the LTE cell 641. In another example, the electronic device 600 may detect the NR SA cell 621 in a boundary area of the first cell 611. In this case, the electronic device 600 may further detect at least one or all of the LTE cell 631 and the LTE cell 641.

Although not shown in FIG. 6, the electronic device 600 may detect at least one other NR SA cell.

In the example shown in FIG. 6, a telecommunications carrier of the first cell 611 may correspond to a telecommunications carrier of a SIM (e.g., the SIM 430 and the DDS SIM of FIG. 4A) of the electronic device 600. The respective telecommunications carrier of the LTE cells 631 and 641 and the telecommunications carrier of the NR SA cell 621 may be different from the telecommunications carrier of the SIM (e.g., the SIM 430 and the DDS SIM of FIG. 4A) of the electronic device 600. For example, the telecommunications carrier of the SIM of the electronic device 600 may be a first telecommunications carrier, the telecommunications carrier of the NR SA cell 621 may be a second telecommunications carrier, the telecommunications carrier of the LTE cell 631 may be a third telecommunications carrier, and the telecommunications carrier of the LTE cell 641 may be the second telecommunications carrier.

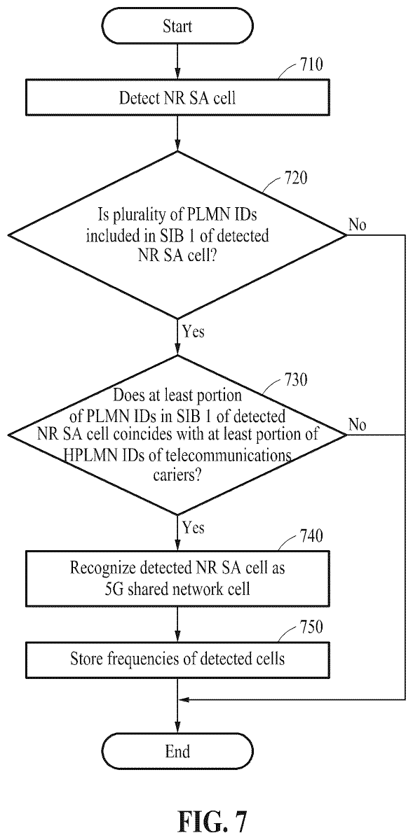

According to an embodiment, the electronic device 600 may determine whether the NR SA cell 621 corresponds to a 5G shared network cell (or the NR SA cell 621 supports the 5G shared network) based on at least a portion of system information on the NR SA cell 621 and system information of the detected LTE cell (e.g., the LTE cell 631 and/or the LTE cell 641). This is described with reference to FIG. 7.

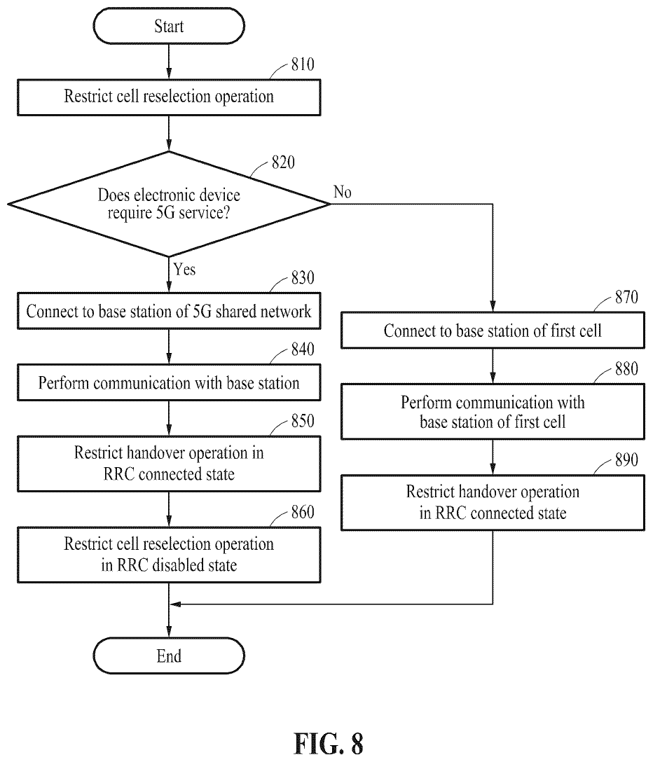

The embodiments to be described with reference to FIG. 7 and the embodiments to be described with reference to FIG. 8 may apply to a case in which the electronic device 600 includes one SIM 430 or a case in which a DDS SIM among a plurality of SIMs is used.

Referring to FIG. 7, in operation 710, the electronic device 600 may detect an NR SA cell (e.g., the NR SA cell 621 of FIG. 6). Although not shown in FIG. 7, the electronic device 600 may detect at least one LTE cell (e.g., the LTE cells 631 and 641 of FIG. 6) and/or at least one another NR SA cell.

In operation 720, the electronic device 600 may check whether a plurality of PLMN IDs is included in an SIB 1 of the detected NR SA cell 621.

When the plurality of PLMN IDs is included in the SIB 1 of the detected NR SA cell 621 (operation 720—Yes), in operation 730, the electronic device 600 may determine whether at least a portion (or all) of the plurality of PLMN IDs in the SIB 1 of the detected NR SA cell 621 coincides with at least a portion (or all) of home PLMN (HPLMN) IDs of telecommunications carriers (e.g., telecommunications carriers of a country where the electronic device 600 is located).

For example, a home network identifier (e.g., an HPLMN ID) of a subscriber of each telecommunications carrier by country may be stored in a memory (e.g., the memory 420 of FIG. 4A and the memory 420-1 of FIG. 4B) of the electronic device 600. Table 1 shown below may show an example of a home network identifier of a subscriber of each telecommunications carrier by country.

TABLE 1

| Country | Telecommunications carrier | Home network identifier |
|---|---|---|
| Korea | First telecommunications | HPLMN ID 1 |
| | carrier | |
| | Second telecommunications | HPLMN ID 2 |
| | carrier | |
| | Third telecommunications | HPLMN ID 3 |
| | carrier | |
| USA | . . . | . . . |
| . . . | . . . | . . . |

In Table 1, HPLMN ID 1 may represent a home network (or an HPLMN) identifier of a subscriber of the first telecommunications carrier in Korea, HPLMN ID 2 may represent a home network (or an HPLMN) identifier of a subscriber of the second telecommunications carrier in Korea, and HPLMN ID 3 may represent a home network (or an HPLMN) identifier of a subscriber of the third telecommunications carrier in Korea.

The electronic device 600 may compare the home network identifiers (e.g., HPLMN ID 1 to HPLMN ID 3 of Table 1) of the telecommunications carrier with the plurality of PLMN IDs in the SIB 1 of the NR SA cell 621. The electronic device 600 may check whether at least a portion (or all) of HPLMN ID 1 to HPLMN ID 3 of Table 1 coincides with a portion (or all) of the plurality of PLMN IDs in the SIB 1 of the detected NR SA cell 621.

In an embodiment, when the plurality of PLMN IDs is included in the SIB 1 of the NR SA cell 621 (operation 720—Yes), the electronic device 600 may check whether the most PLMN IDs are included in the SIB 1 of the NR SA cell 621 among the SIB 1 of the first cell 611, the SIB 1 of the NR SA cell 621, and respective SIB 1s of the detected other cells (e.g., the detected LTE cells 631 and 641). The electronic device 600 may determine whether the most PLMN IDs are included in the SIB 1 of the NR SA cell 621 and the PLMN ID in the SIB 1 of the first cell 611 and respective PLMN IDs in SIB Is of the detected other cells (e.g., the detected LTE cells 631 and 641) coincide with at least a portion of the PLMN IDs in the SIB 1 of the NR SA cell 621.

For example, as shown in the example of Table 2 below, the SIB 1 of the first cell 611 may include one PLMN ID, the SIB 1 of the NR SA cell 621 may include three PLMN IDs, the SIB 1 of the detected LTE cell 631 may include two PLMN IDs, and the SIB 1 of the detected LTE cell 641 may include one PLMN ID.

TABLE 2

| | |
|---|---|
| First cell 611 | HPLMN ID 1 |
| NR SA cell 621 | HPLMN ID 1, HPLMN ID 2, |
| | HPLMN ID 3 |
| LTE cell 631 | HPLMN ID 2, E(equivalent)- |
| | PLMN ID of HPLMN ID |
| LTE cell 641 | HPLMN ID 3 |

The electronic device 600 may determine that the SIB 1 of the NR SA cell 621 includes the most PLMN IDs. The electronic device 600 may determine whether a portion of the two PLMN IDs in the SIB 1 of the detected LTE cell 631 coincides with a portion of the three PLMN IDs in the SIB 1 of the NR SA cell 621. Similarly, the electronic device 600 may determine whether the PLMN ID in the SIB 1 of the first cell 611 and the PLMN ID in the SIB 1 of the detected LTE cell 641 coincide with a portion of the three PLMN IDs in the SIB 1 of the NR SA cell 621.

When at least a portion of the plurality of PLMN IDs in the SIB 1 of the detected NR SA cell 621 coincides with at least a portion of the HPLMN IDs of the telecommunications carriers (operation 730—Yes) (or when the PLMN ID in the SIB 1 of the first cell 611 and the respective PLMN IDs in the SIB Is of the detected other cells coincide with at least a portion of the PLMN IDs in the SIB 1 of the NR SA cell 621), in operation 740, the electronic device 600 may recognize the detected NR SA cell 621 as a 5G shared network cell.

For example, when HPLMN ID 1 to HPLMN ID 3 of Table 1 exist in the plurality of PLMN IDs in the SIB 1 of the detected NR SA cell 621 (when at least a portion (or all) of the plurality of PLMN IDs in the SIB 1 of the detected NR SA cell 621 coincides with at least a portion (or all) of HPLMN ID 1 to HPLMN ID 3 of Table 1), the electronic device 600 may recognize the detected NR SA cell 621 as a 5G shared network cell. In another example, the electronic device 600 may check that the NR SA cell 621 includes the most PLMN IDs. The electronic device 600 may determine that the PLMN ID (e.g., HPLMN ID 1 of Table 2) of the first cell 611 coincides with a portion (e.g., HPLMN ID 1 of Table 2) of the PLMN IDs of the NR SA cell 621, the PLMN ID (e.g., HPLMN ID 2 of Table 2) of the LTE cell 631 coincides with a portion (e.g., HPLMN ID 2 of Table 2) of the PLMN IDs of the NR SA cell 621, and the PLMN ID (e.g., HPLMN ID 3 of Table 2) of the LTE cell 641 coincides with a portion (e.g., HPLMN ID 3 of Table 2) of the PLMN IDs of the NR SA cell 621. In this case, the electronic device 600 may recognize the detected NR SA cell 621 as the 5G shared network cell.

Depending on the embodiment, when at least a portion of the plurality of PLMN IDs in the SIB 1 of the detected NR SA cell 621 coincides with at least a portion of the HPLMN IDs of the telecommunications carriers (operation 730—Yes) (or when the PLMN ID in the SIB 1 of the first cell 611 and the respective PLMN IDs of SIB Is of the detected other cells coincide with at least a portion of the PLMN IDs in the SIB 1 of the NR SA cell 621), the electronic device 600 may check whether an upper layer indicator of an SIB 2 of the detected LTE cell (e.g., the LTE cells 631 and 641 of FIG. 6) indicates false. The upper layer indicator may be an indicator for indicating whether the detected LTE cell is capable of evolved universal terrestrial radio access network (E-UTRAN) new radio-dual connectivity (EN-DC). When the upper layer indicator of the SIB 2 of the detected LTE cell indicates false, in operation 740, the electronic device 600 may recognize the detected NR SA cell 621 as a 5G shared network cell. The electronic device 600 may determine that the detected NR SA cell 621 supports the 5G shared network.

In operation 750, the electronic device 600 may store frequencies of the detected cells (e.g., the NR SA cell 621, at least one another NR SA cell, and the LTE cells 631 and 641) in a memory (e.g., the memory 420 of FIG. 4A and the memory 420-1 of FIG. 4B). In addition, the electronic device 600 may store a frequency of a most recently camp-on cell (e.g., the first cell 611) in a memory (e.g., the memory 420 of FIG. 4A and the memory 420-1 of FIG. 4B). For example, the electronic device 600 may generate a frequency list (or a frequency database (DB)) by listing the frequency of the first cell 611 and respective frequencies of the detected cells (e.g., the NR SA cell 621, the other NR SA cell, and the LTE cells 631 and 641) by telecommunications carriers and may store the generated frequency list (or the frequency DB) in the memory. Table 3 shown below may show an example of the frequency list (or the frequency DB) generated through operation 750.

TABLE 3

| Telecommunications carrier | Frequency |
|---|---|
| First telecommunications carrier | NR band: first NR frequency |
| (e.g., telecommunications carrier | LTE band: first LTE frequency, |
| of SIM of electronic device 600) | second LTE frequency |
| Second telecommunications carrier | NR band: second NR frequency |
| (e.g., telecommunications carriers | LTE band: third LTE frequency, |
| of NR SA cell 621 and LTE cell 641) | fourth LTE frequency |
| Third telecommunications carrier | NR band: third NR frequency |
| (e.g., telecommunications carrier | LTE band: fifth LTE frequency, |
| of LTE cell 631) | sixth LTE frequency |

As described with reference to FIG. 6, the electronic device 600 may determine whether to perform a cell reselection operation with reference to (or using) the generated frequency list (e.g., Table 3) or may determine whether to perform a handover operation.

According to an embodiment, when the electronic device 600 recognizes (or determines) the NR SA cell 621 as the 5G shared network cell (or determines that the NR SA cell 621 supports the 5G shared network), the electronic device 600 may camp on the NR SA cell 621. Hereinafter, with reference to FIG. 8, an operation of the electronic device 600 in the 5G shared network (e.g., the NR SA cell 621) is described.

Referring to FIG. 8, in operation 810, the electronic device 600 may restrict a cell reselection operation. In an RRC idle state, the electronic device 600 may camp on the NR SA cell 621 and may restrict the cell reselection operation to maintain a state of camping on the NR SA cell 621. In an area where a network of a subscription telecommunications carrier and a 5G shared network coexist, mobility management entities (MMEs) and/or tracking area identities (TAIs) of the subscription telecommunications carrier and the 5G shared network may be different from each other. Due to this, a TAU operation may be performed for every cell reselection, and a TAU operation may be further performed in the area where the network of the subscription telecommunications carrier and the 5G shared network coexist, and thereby, the number of signaling times may increase. According to an embodiment, the electronic device 600 may restrict the cell reselection operation to maintain a state of camping on the 5G shared network cell (e.g., the NR SA cell 621) in the RRC idle state. Accordingly, the number of signaling times in the area where the network of the subscription telecommunications carrier and the 5G shared network coexist may not significantly increase.

According to an embodiment, in operation 810, the electronic device 600 may block (or prohibit) the reselection of an inter-RAT cell. A processor (e.g., the processor 120 of FIG. 1, the processor 210 of FIG. 2, the processor 410 of FIG. 4A, and the processor 410-1 of FIG. 4B) of the electronic device 600 may control to not perform inter-RAT cell reselection. The inter-RAT cell may be a cell using an RAT (e.g., 4G) that is different from the NR SA cell 621. For example, the electronic device 600 may not reselect the inter-RAT cell even if the reception level of the inter-RAT cell is higher than the reception level of the NR SA cell 621 by a predetermined level or more.

According to an embodiment, in operation 810, the electronic device 600 may restrictively allow an inter-frequency cell reselection operation and/or an intra-frequency cell reselection operation. For example, the electronic device 600 may check neighboring cell (e.g., a neighboring 5G cell) information through system information (e.g., at least one of SIB 3, SIB 4, and SIB 5) on the NR SA cell 621. The processor of the electronic device 600 may check whether a telecommunications carrier of the NR SA cell 621 is the same as a telecommunications carrier of the neighboring cell (e.g., the neighboring 5G cell).

When the telecommunications carrier of the NR SA cell 621 is the same as the telecommunications carrier of the neighboring 5G cell, the electronic device 600 may identify whether a frequency of the neighboring 5G cell exists in a frequency list (or a frequency DB) (e.g., the frequency list (or the frequency DB) generated in operation 750). The electronic device 600 may not perform the cell reselection operation (e.g., the inter-frequency cell reselection operation and/or the intra-frequency cell reselection operation) when the frequency of the neighboring 5G cell does not exist in the frequency list. The processor of the electronic device 600 may control to not perform the cell reselection operation. For example, the electronic device 600 may identify that the telecommunications carrier of the neighboring 5G cell is the second telecommunications carrier, which is the telecommunications carrier of the NR SA cell 621. The electronic device 600 may identify the frequency of the neighboring 5G cell as a fourth NR frequency. The electronic device 600 may identify that the fourth NR frequency does not exist in the frequency of the second telecommunications carrier of the frequency list in Table 3 and may not perform the cell reselection operation. The electronic device 600 may maintain the state in which the electronic device 600 is camped on the NR SA cell 621 by not performing the cell reselection operation. The electronic device 600 may perform the cell reselection operation when the frequency of the neighboring 5G cell exists in the frequency list.

According to an embodiment, in operation 810, when the telecommunications carrier of the NR SA cell 621 is different from the telecommunications carrier of the neighboring 5G cell, the electronic device 600 may perform the cell reselection operation (e.g., the inter-frequency cell reselection operation and/or the intra-frequency cell reselection operation) if a reception level Srxlev of a cell reselection condition (or criteria) (e.g., a cell selection condition) is less than or equal to a specific value. For example, Srxlev may be calculated to be a first reception level value (e.g., 13 dB) based on reference signal received power (RSRP) and/or reference signal received quality (RSRQ). The electronic device 600 may not perform the cell reselection operation when Srxlev is the first reception level value (e.g., 13 dB) and may perform the cell reselection operation when Srxlev is less than or equal to a second reception level (e.g., 10 dB).

According to an embodiment, in operation 810, when the telecommunications carrier of the NR SA cell 621 is different from the telecommunications carrier of the neighboring 5G cell, the electronic device 600 may determine whether the reception level (e.g., Srxlev) of the NR SA cell 621 is greater than a threshold value (hereinafter, referred to as a “first threshold value”). In this case, the first threshold value may be a value less than a reception level threshold value (e.g., an S IntraSearchP value and/or an SnonIntraSearchP value) in the SIB 3 of the NR SA cell 621. The electronic device 600 may determine a value that is less than the reception level threshold value (e.g., the SintraSearchP value and/or the SnonIntraSearchP value) in the SIB 3 of the NR SA cell 621 to be the first threshold value and may compare the reception level of the camp-on NR SA cell 621 with the first threshold value. When the reception level of the NR SA cell 621 is greater than the first threshold value, the electronic device 600 may not perform the cell reselection operation. When the reception level of the NR SA cell 621 is greater than the first threshold value, the processor of the electronic device 600 may control to not perform the cell reselection operation. When the reception level of the NR SA cell 621 is less than or equal to the first threshold value, the electronic device 600 may perform the cell reselection operation.

In operation 820, the electronic device 600 may determine whether the electronic device 600 requires the 5G service. For example, when the electronic device 600 receives a paging message (or a packet switch (PS) paging message) for the 5G service from the NR SA cell 621 or data (e.g., packet data of the 5G service category) to be transmitted to the electronic device 600 exists, the electronic device 600 may determine that the electronic device 600 requires the 5G service.

When the electronic device 600 requires the 5G service (operation 820—Yes), in operation 830, the electronic device 600 may connect to a base station (e.g., the base station 620) of the 5G shared network (e.g., the NR SA cell 621). According to the connection, an RRC state of the electronic device 600 may be changed from the RRC idle state to the RRC connected state.

In operation 840, the electronic device 600 may communicate with the base station (e.g., the base station 620) of the 5G shared network (e.g., the NR SA cell 621). For example, the electronic device 600 may receive data (e.g., the packet data of the 5G service category) from the base station 620 or may transmit the data (e.g., the packet data of the 5G service category) to the base station 620. The electronic device 600 may be provided with the 5G service from the NR SA cell 621.

In operation 850, the electronic device 600 may restrict a handover operation in the RRC connected state. As described above, in the area where the network of the subscription telecommunications carrier and the 5G shared network coexist, the number of signaling times may increase because a TAU operation may be further performed compared to the network of the subscription telecommunications carrier. The electronic device 600 in an embodiment may restrict the handover operation such that the number of signaling times does not significantly increase in the area where the network of the subscription telecommunications carrier and the 5G shared network coexist.

According to an embodiment, in operation 850, the electronic device 600 may block (or prohibit) an inter-RAT handover operation. The processor of the electronic device 600 may control to not perform the inter-RAT handover operation. The electronic device 600 may prevent and/or reduce inter-RAT handover even if the signal quality of an inter-RAT neighboring cell is higher than the signal quality of the NR SA cell 621 by a predetermined level or more. For example, even if the signal quality of the NR SA cell 621 is higher than the signal quality of the inter-RAT neighboring cell by a predetermined level of more, the electronic device 600 may not transmit a measurement report to the base station 620 of the NR SA cell 621.

According to an embodiment, in operation 850, the electronic device 600 may restrictively allow inter-handover and/or intra-handover.

According to an embodiment, in operation 850, the electronic device 600 may check whether the telecommunications carrier of the NR SA cell 621 is the same as the telecommunications carrier of the neighboring 5G cell. When the telecommunications carrier of the NR SA cell 621 is the same as the telecommunications carrier of the neighboring 5G cell, the electronic device 600 may identify whether a frequency of the neighboring 5G cell exists in a frequency list (or a frequency DB) (e.g., the frequency list (or the frequency DB) generated in operation 750). The electronic device 600 may not perform the handover operation (e.g., the inter-handover operation and/or the intra-handover operation) when the frequency of the neighboring 5G cell does not exist in the frequency list. The processor of the electronic device 600 may control to not perform the handover operation when the frequency of the neighboring 5G cell does not exist in the frequency list. Even if the signal quality of the neighboring 5G cell is higher than the signal quality of the NR SA cell 621 by a predetermined level or more, when the frequency of the neighboring 5G cell does not exist in the frequency list, the electronic device 600 may prevent and/or reduce handover to the neighboring 5G cell.

According to an embodiment, in operation 850, when the telecommunications carrier of the NR SA cell 621 is different from the telecommunications carrier of the neighboring 5G cell of which a signal is measured, the electronic device 600 may perform the handover operation (e.g., the inter-handover operation and/or the intra-handover operation) when a reception level Srxlev of a handover condition (e.g., the cell selection condition) is less than or equal to a specific value. For example, Srxlev may be calculated to be a first reception level value (e.g., 13 dB) based on RSRP or RSRQ. The electronic device 600 may not perform the handover operation when Srxlev is the first reception level value (e.g., 13 dB) and may perform the handover operation when Srxlev is less than or equal to a second reception level (e.g., 10 dB).

According to an embodiment, in operation 850, when the telecommunications carrier of the NR SA cell 621 is different from the telecommunications carrier of the neighboring 5G cell of which a signal is measured, the electronic device 600 may adjust a handover parameter to restrictively perform the handover operation. For example, the electronic device 600 may lower a threshold value (e.g., a threshold value of an A2 event) for a handover event described in 3GPP TS and may determine whether a handover event (e.g., the A2 event) occurs by comparing the lowered threshold value with the reception level of the NR SA cell 621. In another example, the electronic device 600 may raise an offset value (e.g., an A3 offset value) and may determine whether a handover event (e.g., an A3 event) occurs through the risen offset value.

According to an embodiment, when there is no data transmission or reception between the electronic device 600 and the base station 620 of the NR SA cell 621 in the RRC connected state, the RRC connection between the electronic device 600 and the NR SA cell 621 may be disconnected and the RRC state of the electronic device 600 may be changed from the RRC connected state to an RRC disabled state.

In operation 860, the electronic device 600 may restrict the cell reselection operation in the RRC disabled state. The description of the restriction of the cell reselection operation in operation 810 may apply to the description of the restriction of the cell reselection operation in operation 860.

When the electronic device 600 does not require the 5G service (operation 820—No), in operation 870, the electronic device 600 may connect to a base station (e.g., the base station 610) of the first cell 611. In operation 870, the electronic device 600 may reselect the first cell 611 and may connect to the base station 610 of the first cell 611. The RRC state of the electronic device 600 may be changed from the RRC idle state to the RRC connected state.

In operation 880, the electronic device 600 may communicate with the base station 610 of the first cell 611. For example, the electronic device 600 may receive a voice call (and/or a text message) based on VOLTE from the base station 610 of the first cell 611 and may transmit a voice call (and/or a text message) based on VOLTE to the base station 610 of the first cell 611.

In operation 890, the electronic device 600 may restrict the handover operation in the RRC connected state. The electronic device 600 may be operated such that handover from the first cell 611 to another cell is restricted.

According to an embodiment, in operation 890, the electronic device 600 may block (or prohibit) inter-RAT handover. The electronic device 600 may prevent and/or reduce inter-RAT handover even if the signal quality of an inter-RAT neighboring cell is higher than the signal quality of the first cell 611 by a predetermined level or more.

According to an embodiment, in operation 890, the electronic device 600 may restrictively allow inter-handover and/or intra-handover of the electronic device 600. For example, the electronic device 600 may check whether the telecommunications carrier of the first cell 611 is the same as the telecommunications carrier of the neighboring LTE cell. When the telecommunications carrier of the first cell 611 is the same as the telecommunications carrier of the neighboring LTE cell, the electronic device 600 may identify whether a frequency of the neighboring LTE cell exists in a frequency list (or a frequency DB) (e.g., the frequency list (or the frequency DB) generated in operation 750). The electronic device 600 may not perform the handover operation when the frequency of the neighboring LTE cell does not exist in the frequency list. The processor of the electronic device 600 may control to not perform the handover operation of the electronic device 600 when the frequency of the neighboring LTE cell does not exist in the frequency list. Even if the signal quality of the neighboring LTE cell is higher than the signal quality of the first cell 611 by a predetermined level or more, when the frequency of the neighboring LTE cell does not exist in the frequency list, the electronic device 600 may prevent and/or reduce handover to the neighboring LTE cell.

According to an embodiment, in operation 890, when the telecommunications carrier of the first cell 611 is different from the telecommunications carrier of the neighboring LTE cell, the electronic device 600 may perform the handover operation when a reception level Srxlev of a handover condition (e.g., the cell selection condition) is less than or equal to a specific value. For example, Srxlev may be calculated to be a first reception level value (e.g., 13 dB) based on RSRP or RSRQ. The electronic device 600 may not perform the handover operation when Srxlev is the first reception level value (e.g., 13 dB) and may perform the handover operation when Srxlev is less than or equal to a second reception level (e.g., 10 dB).

According to an embodiment, in operation 890, when the telecommunications carrier of the first cell 611 is different from the telecommunications carrier of the neighboring LTE cell, the electronic device 600 may adjust a handover parameter to restrictively perform the handover operation. For example, the electronic device 600 may lower a threshold value (e.g., the threshold value of the A2 event) for a handover event described in 3GPP TS such that the handover event (e.g., the A2 event) restrictively occurs. In another example, the electronic device 600 may raise an offset value (e.g., the A3 offset value) such that the handover event (e.g., the A3 event) restrictively occurs.

According to an embodiment, the electronic device 600 and the 5G shared network (e.g., the NR SA cell 621) may support VONR. Whether a voice call to be transmitted to the electronic device 600 or a voice call to be transmitted by the electronic device 600 exists, in operation 830, the electronic device 600 may connect to the base station of the 5G shared network (e.g., the NR SA cell 621). In operation 840, the electronic device 600 may receive a VoNR voice call from the base station of the 5G shared network (e.g., the NR SA cell 621) or may transmit a VoNR voice call to the base station of the 5G shared network (e.g., the NR SA cell 621). The electronic device 600 may be provided with a VoNR service. The electronic device 600 may restrict the handover operation in the RRC connected state.

According to an embodiment, the electronic device 600 may support VONR but the 5G shared network (e.g., the NR SA cell 621) may not support VONR. Whether a voice call to be transmitted to the electronic device 600 or a voice call to be transmitted by the electronic device 600 exists, in operation 870, the electronic device 600 may connect to the base station (e.g., the base station 610) of the first cell 611 through a fallback of the 5G shared network (e.g., the NR SA cell 621). The electronic device 600 may receive a VOLTE voice call from the base station (e.g., the base station 610) of the first cell 611 or may transmit a VOLTE voice call to the base station (e.g., the base station 610) of the first cell 611. The electronic device 600 may be provided with the VOLTE service. The electronic device 600 may restrict the handover operation in the RRC connected state.

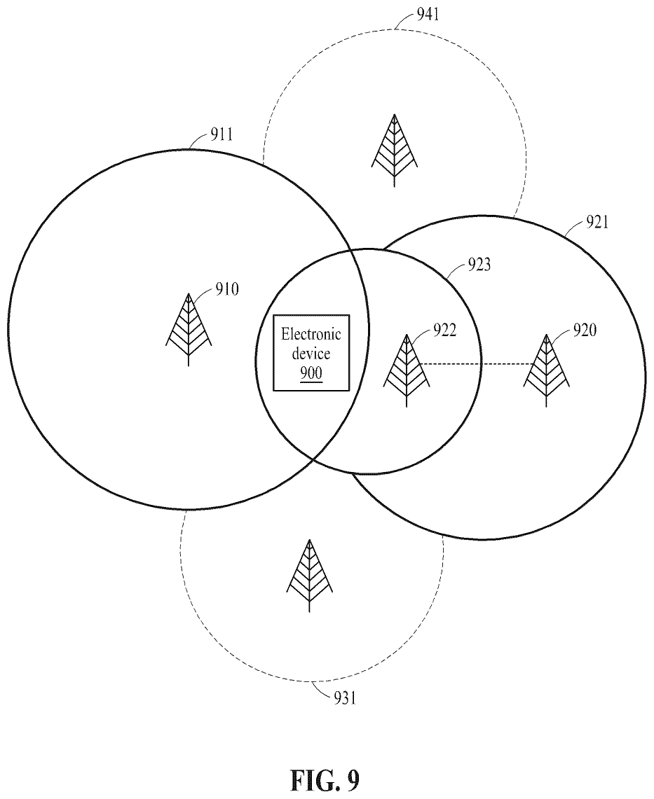

FIGS. 9, 10, 11A and 11B include a diagram and flowcharts illustrating an example operation of an electronic device in NR non-standalone (NSA) according to various embodiments.

In the example shown in FIG. 9, an electronic device 900 (e.g., the electronic device 101 of FIGS. 1 to 3, the electronic device 400 of FIG. 4A, the electronic device 400-1 of FIG. 4B, and the electronic device 600 of FIG. 6) may detect multiple cells (e.g., at least one LTE cell) through frequency scanning or frequency-based network search. For example, the electronic device 900 may detect a first cell 911 (e.g., the first cell 311 of FIG. 3) and LTE cells 921, 931, and 941.

According to an embodiment, the electronic device 900 may detect multiple cells (e.g., at least one LTE cell) in various circumstances. For example, when the electronic device 900 moves from the first cell 911 to the first LTE cell 921, the electronic device 900 may detect the first LTE cell 921. In this case, the electronic device 900 may further detect at least one of the second LTE cell 931 and the third LTE cell 941. In another example, when the electronic device 900 is booted (or is turned on) in an area where the first cell 911 overlaps the first LTE cell 921, the electronic device 900 may detect at least one or all of the first cell 911, the first LTE 921, the second LTE cell 931, or the third LTE cell 941. In another example, the electronic device 900 may detect the first LTE cell 921 in a boundary area of the first cell 911. In this case, the electronic device 900 may further detect at least one or all of the second LTE cell 931 and the third LTE cell 941.

In the example shown in FIG. 9, the first LTE cell 921 may support EN-DC, and a base station 922 of a 5G cell 923 of the first LTE cell 921 may be connected to a base station 920 of the first LTE cell 921. The base station 920 of the first LTE cell 921 may operate as a master base station and the base station 922 of the 5G cell 923 may operate as, for example, a secondary base station. According to an embodiment, when an upper layer indicator included in an SIB 2 of the first LTE cell 921 indicates true, the electronic device 900 may recognize that the first LTE cell 921 supports EN-DC and the 5G cell 923 exists.

In the example shown in FIG. 9, a telecommunications carrier of the first cell 911 may correspond to a telecommunications carrier of a SIM (e.g., the SIM 430 and the DDS SIM of FIG. 4A) of the electronic device 900. Respective telecommunications carrier of the LTE cells 921, 931, and 941 may be different from the telecommunications carrier of the SIM (e.g., the SIM 430 and the DDS SIM of FIG. 4A) of the electronic device 900. For example, the telecommunications carrier of the SIM of the electronic device 900 may be a first telecommunications carrier, the telecommunications carrier of the first LTE cell 921 may be a second telecommunications carrier, the telecommunications carrier of the second LTE cell 931 may be a third telecommunications carrier, and the telecommunications carrier of the third LTE cell 941 may be the second telecommunications carrier.

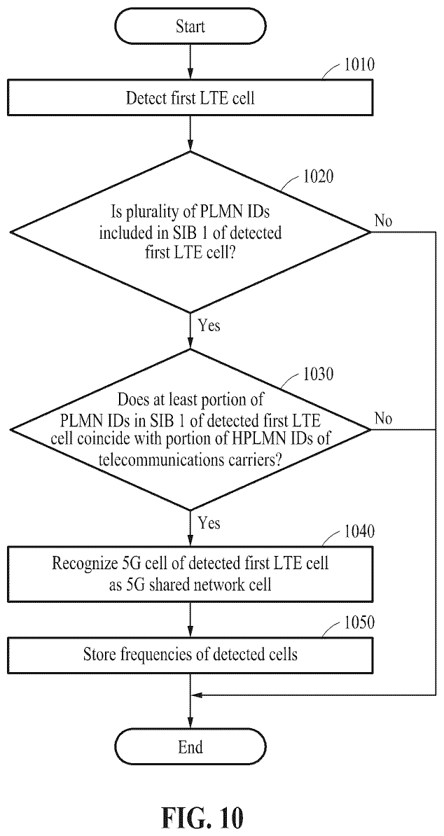

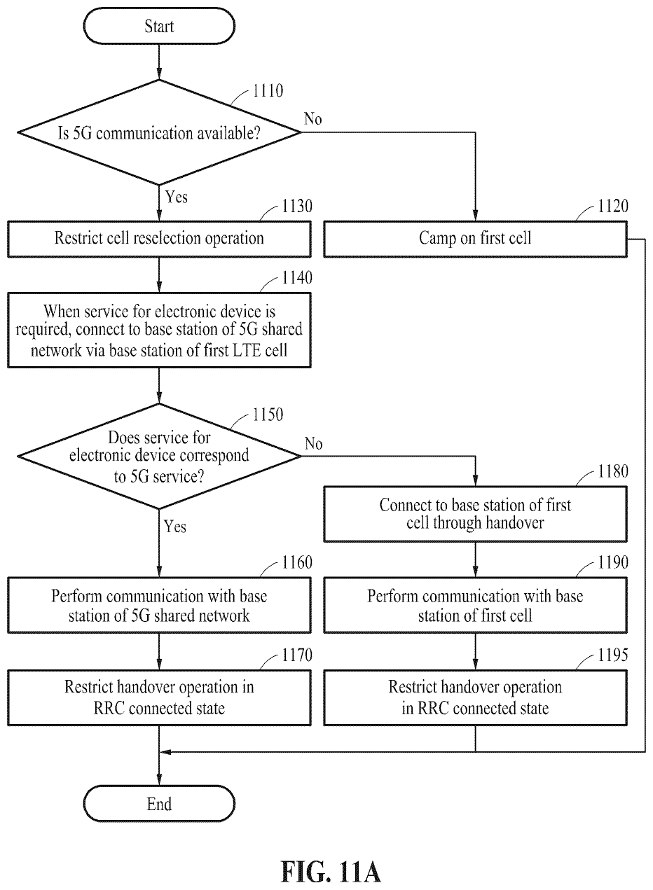

According to an embodiment, the electronic device 900 may determine whether the 5G cell 923 of the first LTE cell 921 corresponds to a 5G shared network cell (or the 5G cell 923 of the first LTE cell 921 supports the 5G shared network) based on at least a portion of system information of the detected first LTE cell 921 and system information of detected at least one another LTE cell (e.g., the LTE cells 931 and 941 of FIG. 9). This is described with reference to FIG. 10.

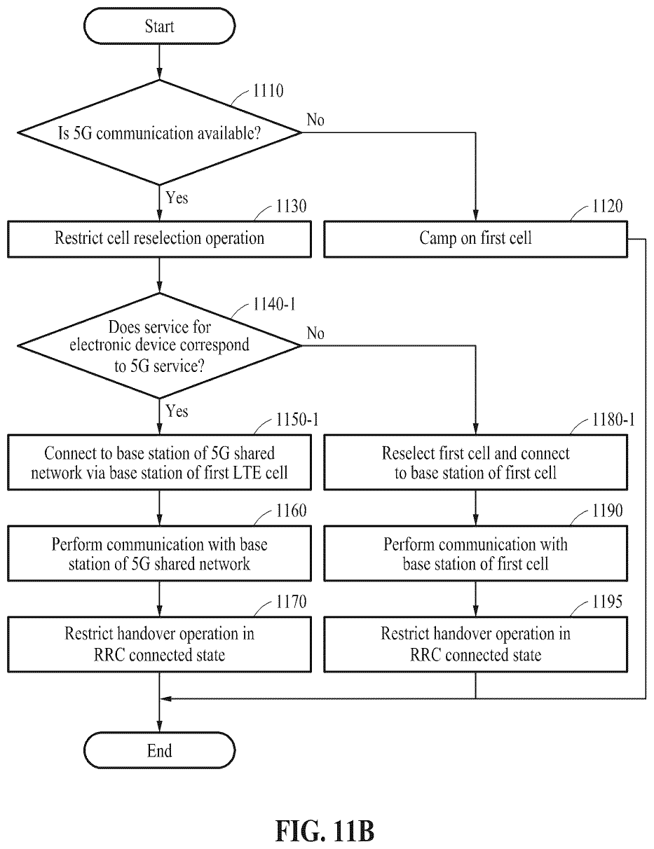

The embodiments to be described with reference to FIG. 10 and the embodiments to be described with reference to FIGS. 11A and 11B may apply to a case in which the electronic device 900 includes one SIM 430 or a case in which a DDS SIM among a plurality of SIMs is used.

Referring to FIG. 10, in operation 1010, the electronic device 900 may detect a first LTE cell (e.g., the first LTE cell 921 of FIG. 9).

In operation 1020, the electronic device 900 may check whether a plurality of PLMN IDs is included in an SIB 1 of the detected first LTE cell 921.

When a plurality of PLMN IDs is included in the SIB 1 of the detected first LTE cell 921 (operation 1020—Yes), in operation 1030, the electronic device 900 may determine whether at least a portion of the plurality of PLMN IDs in the SIB 1 of the detected first LTE cell 921 coincides with at least a portion of HPLMN IDs of telecommunications carriers (e.g., telecommunications carriers of a country where the electronic device 900 is located). For example, the electronic device 900 may compare the HPLMN IDs (e.g., HPLMN ID 1 to HPLMN ID 3 of Table 1) of the telecommunications carriers with the plurality of PLMN IDs in the SIB 1 of the detected first LTE cell 921. The electronic device 900 may check whether at least a portion (or all) of HPLMN ID 1 to HPLMN ID 3 of Table 1 coincides with a portion (or all) of the plurality of PLMN IDs in the SIB 1 of the detected first LTE cell 921.

In an embodiment, when the plurality of PLMN IDs is included in the SIB 1 of the first LTE cell 921 (operation 1020—Yes), the electronic device 900 may check whether the most PLMN IDs are included in the SIB 1 of the first LTE cell 921 among the SIB 1 of the first cell 911, the SIB 1 of the first LTE cell 921, and respective SIB Is of the detected other cells (e.g., the detected LTE cells 931 and 941). When the most PLMN IDs are included in the SIB 1 of the first LTE cell 921, the electronic device 900 may determine whether the PLMN ID in the SIB 1 of the first cell 911 and the PLMN IDs in the SIB Is of the detected other cells (e.g., the detected LTE cells 931 and 941) coincide with at least a portion of the PLMN IDs in the SIB 1 of the first LTE cell 921.

For example, as shown in the example of Table 4 below, the SIB 1 of the first cell 911 may include one PLMN ID, the SIB 1 of the first LTE cell 921 may include three PLMN IDs, the SIB 1 of the second LTE cell 931 may include two PLMN IDs, and the SIB 1 of the third LTE cell 941 may include one PLMN ID.

TABLE 4

| | |
|---|---|
| First cell 911 | HPLMN ID 1 |
| First LTE cell 921 | HPLMN ID 1, HPLMN ID 2, |
| | HPLMN ID 3 |
| Second LTE cell 931 | HPLMN ID 2, E(equivalent)- |
| | PLMN ID of HPLMN ID |
| Third LTE cell 941 | HPLMN ID 3 |

The electronic device 900 may determine that the SIB 1 of the first LTE cell 921 includes the most PLMN IDs. The electronic device 900 may determine whether a portion of the two PLMN IDs in the SIB 1 of the detected second LTE cell 931 coincides with a portion of the three PLMN IDs in the SIB 1 of the first LTE cell 921. Similarly, the electronic device 900 may determine whether the PLMN ID in the SIB 1 of the first cell 911 and the PLMN ID in the SIB 1 of the detected third LTE cell 941 coincide with a portion of the three PLMN IDs in the SIB 1 of the first LTE cell 921.

When at least a portion of the plurality of PLMN IDs in the SIB 1 of the first LTE cell 921 coincides with at least a portion of the HPLMN IDs of the telecommunications carriers (operation 1030—Yes) (or when the PLMN ID in the SIB 1 of the first cell 911 and the respective PLMN IDs in the SIB Is of the detected other LTE cells (e.g., the LTE cells 931 and 941) coincide with at least a portion of the PLMN IDs in the SIB 1 of the first LTE cell 921), in operation 1040, the electronic device 900 may recognize (or determine) the 5G cell 923 of the detected first LTE cell 921 as a 5G shared network cell. In operation 1040, the electronic device 900 may determine that the 5G cell 923 supports the 5G shared network.

For example, when HPLMN ID 1 to HPLMN ID 3 of Table 1 exist in the plurality of PLMN IDs in the SIB 1 of the detected first LTE cell 921 (or when at least a portion (or all) of the plurality of PLMN IDs in the SIB 1 of the detected first LTE cell 921 coincides with at least a portion (or all) of HPLMN ID 1 to HPLMN ID 3 of Table 1), the electronic device 900 may recognize the 5G cell 923 of the detected first LTE cell 921 as a 5G shared network cell. In another example, the electronic device 900 may check that the first LTE cell 921 includes the most PLMN IDs. The electronic device 900 may determine that the PLMN ID (e.g., HPLMN ID 1 of Table 4) of the first cell 911 coincides with a portion (e.g., HPLMN ID 1 of Table 4) of the PLMN IDs of the first LTE cell 921, the PLMN ID (e.g., HPLMN ID 2 of Table 4) of the second LTE cell 931 coincides with a portion (e.g., HPLMN ID 2 of Table 4) of the PLMN IDs of the first LTE cell 921, and the PLMN ID (e.g., HPLMN ID 3 of Table 4) of the third LTE cell 941 coincides with a portion (e.g., HPLMN ID 3 of Table 4) of the PLMN IDs of the first LTE cell 921. In this case, the electronic device 900 may recognize the 5G cell 923 of the first LTE cell 921 as the 5G shared network cell.

Depending on the embodiment, when at least a portion of the plurality of PLMN IDs in the SIB 1 of the first LTE cell 921 coincides with at least a portion of the HPLMN IDs of the telecommunications carriers (operation 1030—Yes) (or when the PLMN ID in the SIB 1 of the first cell 911 and the respective PLMN IDs of SIB Is of the detected other LTE cells (e.g., the LTE cells 931 and 941) coincide with at least a portion of the PLMN IDs in the SIB 1 of the first LTE cell 921), the electronic device 900 may check whether an upper layer indicator of an SIB 2 of the first LTE cell 921 indicates true and an upper layer indicator of an SIB 2 of the detected other LTE cell indicates false. When the upper layer indicator of the SIB 2 of the detected LTE cell 921 indicates true and the upper layer indicator of the SIB 2 of the detected other LTE cell (e.g., the LTE cells 931 and 941) indicates false, in operation 1040, the electronic device 900 may recognize (or determine) the 5G cell 923 of the detected first LTE cell 921 as a 5G shared network cell. In operation 1040, the electronic device 900 may determine that the 5G cell 923 supports the 5G shared network.

In operation 1050, the electronic device 900 may store frequencies of the detected cells (e.g., the LTE cells 921, 931, and 941) in a memory (e.g., the memory 420 of FIG. 4A and the memory 420-1 of FIG. 4B). In addition, the electronic device 600 may store a frequency of a most recently camp-on cell (e.g., the first cell 911) in a memory (e.g., the memory 420 of FIG. 4A and the memory 420-1 of FIG. 4B). For example, the electronic device 900 may generate a frequency list (or a frequency database (DB)) by listing the frequency of the first cell 911 and respective frequencies of the detected cells (e.g., the LTE cells 921, 931, and 941) by telecommunications carriers and may store the generated frequency list (or the frequency DB) in the memory. Table 5 shown below may show an example of the frequency list (or the frequency DB) generated through operation 1050.

TABLE 5

| Telecommunications carrier | Frequency |
|---|---|
| First telecommunications carrier | LTE band: first LTE frequency, |
| (e.g., telecommunications carrier | second LTE frequency |
| of SIM of electronic device 900) | |
| Second telecommunications carrier | NR band: first NR frequency |
| (e.g., telecommunications carriers | LTE band: third LTE frequency, |
| of first LTE cell 921, 5G cell | fourth LTE frequency |
| 923, and third LTE cell 941) | |
| Third telecommunications carrier | LTE band: fifth LTE frequency, |
| (e.g., telecommunications carrier | sixth LTE frequency |
| of second LTE cell 931) | |

Since the first LTE cell 921 of the second telecommunications carrier may support EN-DC, the electronic device 900 may identify a frequency (e.g., the first NR frequency of Table 5) of the 5G cell 923 of the first LTE cell 921 and may store the frequency in the memory.

As described with reference to FIG. 11A, the electronic device 900 may determine whether to perform a cell reselection operation with reference to (or using) the generated frequency list (e.g., Table 5) or may determine whether to perform a handover operation.

According to an embodiment, a plurality of PLMN IDs included in an SIB 1 of the detected first LTE cell 921 may correspond to one telecommunications carrier. For example, the SIB 1 of the detected first LTE cell 921 may only include a PLMN ID of the second telecommunications carrier and an E-PLMN ID of a PLMN of the second telecommunications carrier. In another example, the SIB 1 of the detected first LTE cell 921 may only include the PLMN ID of the second telecommunications carrier and a PLMN ID of an emergency communication network. In this case, since the 5G cell 923 of the detected first LTE cell 921 is not a 5G shared network cell but the SIB 1 of the detected first LTE cell 921 includes the plurality of PLMN IDs, the electronic device 900 may falsely recognize that the 5G cell 923 of the detected first LTE cell 921 is a 5G shared network cell.

According to an embodiment, when the electronic device 900 recognizes (or determines) that the 5G cell 923 of the first LTE cell 921 is a 5G shared network cell (or determines that the 5G cell 923 supports the 5G shared network), the electronic device 900 may camp on the first LTE cell 921. Hereinafter, an example operation of the electronic device 900 in the 5G shared network is described with reference to FIGS. 11A and 11B.

Referring to FIG. 11A, in operation 1110, the electronic device 900 may check whether 5G communication is available. For example, the electronic device 900 may receive a first message from the base station 920 of the first LTE cell 921 wherein the first message includes an indicator (e.g., restrictDCNR=false) that sets the base station 920 to enable dual connectivity with NR. The first message may include, for example, an attach accept message in which restrictDCNR is set to false or a TAU accept message in which restrictDCNR is set to false. When the electronic device 900 receives the first message, the electronic device 900 may check that the electronic device 900 is able to use the 5G communication.

The electronic device 900 may receive a second message from the base station 920 of the first LTE cell 921, wherein the second message includes an indicator (e.g., restrictDCNR=true) that sets the base station 920 to disable dual connectivity with NR. The second message may include, for example, an attach accept message in which restrictDCNR is set to true or a TAU accept message in which restrictDCNR is set to true. When the electronic device 900 receives the second message, the electronic device 900 may check that 5G communication of the electronic device 900 is not available. According to an embodiment, when the electronic device 900 supports 5G but a price plan of the electronic device 900 is an LTE plan, the electronic device 900 may receive the second message from the base station 920.

The electronic device 900 may receive a TAU reject message from the base station 920 of the first LTE cell 921. When the electronic device 900 receives the TAU reject message, the electronic device 900 may check that 5G communication of the electronic device 900 is not available.

When the 5G communication is not available (operation 1110—No), in operation 1120, the electronic device 900 may camp on the first cell 911. For example, when the electronic device 900 receives the second message or the TAU reject message, the electronic device 900 may reselect the first cell 911 and may camp on the first cell 911.

According to an embodiment, when the electronic device 900 receives the TAU reject message from the base station 920 in operation 1110 and camps on the first cell 911 in operation 1120, the electronic device 900 may perform at least one of a location network registration procedure (e.g., an attach procedure), an internet protocol (IP) multimedia subsystem (IMS) registration procedure, or a rich communication suite (RCS) registration procedure to prevent and/or reduce a missing call.

When the 5G communication is available (operation 1110—Yes), in operation 1130, the electronic device 900 may restrict the cell reselection operation. When the 5G communication is available, a processor (e.g., the processor 120 of FIG. 1, the processor 210 of FIG. 2, the processor 410 of FIG. 4A, and the processor 410-1 of FIG. 4B) of the electronic device 900 may control to restrict the cell reselection operation of the electronic device 900. The electronic device 900 may be in a state in which the electronic device 900 camps on the first LTE cell 921. When the 5G communication is available and/or a TAU approval is obtained, the electronic device 900 may restrict the cell reselection operation to maintain the state in which the electronic device 900 camps on the first LTE cell 921.

According to an embodiment, in operation 1130, the electronic device 900 may block (or prohibit) the reselection of an inter-RAT cell. The processor of the electronic device 900 may control to not perform a reselection operation of the inter-RAT cell.

According to an embodiment, in operation 1130, the electronic device 900 may restrictively allow an inter-frequency cell reselection operation and/or an intra-frequency cell reselection operation. For example, the electronic device 900 may check neighboring LTE cell information through system information (e.g., at least one of the SIB 3, SIB 4, and SIB 5) of the first LTE cell 921. The electronic device 600 may check whether the telecommunications carrier of the first LTE cell 921 is the same as the telecommunications carrier of the neighboring LTE cell.

According to an embodiment, in operation 1130, when the telecommunications carrier of the first LTE cell 921 is the same as the telecommunications carrier of the neighboring LTE cell, the electronic device 900 may identify whether a frequency of the neighboring LTE cell exists in a frequency list (or a frequency DB) (e.g., the frequency list (or the frequency DB) generated in operation 1050). The electronic device 900 may not perform the cell reselection operation when the frequency of the neighboring LTE cell does not exist in the frequency list. The processor of the electronic device 900 may control to not perform the cell reselection operation of the electronic device 900 when the frequency of the neighboring LTE cell does not exist in the frequency list. In this case, the electronic device 900 may maintain the state in which the electronic device 900 camps on the first LTE cell 921. When the frequency of the neighboring LTE cell exists in the frequency list, the electronic device 900 may perform the cell reselection operation.

According to an embodiment, in operation 1130, when the telecommunications carrier of the first LTE cell 921 is different from the telecommunications carrier of the neighboring LTE cell, the electronic device 900 may perform the cell reselection operation when a reception level Srxlev of a cell reselection condition (e.g., the cell selection condition) is less than or equal to a specific value. For example, Srxlev may be calculated to be a first reception level value (e.g., 13 dB) based on RSRP and/or RSRQ. The electronic device 600 may not perform the cell reselection operation when Srxlev is the first reception level value (e.g., 13 dB) and may perform the cell reselection operation when Srxlev is less than or equal to a second reception level (e.g., 10 dB).

According to an embodiment, in operation 1130, when the telecommunications carrier of the first LTE cell 921 is different from the telecommunications carrier of the neighboring LTE cell, the electronic device 900 may determine whether the reception level (e.g., Srxlev) of the first LTE cell 921 is greater than a threshold value (hereinafter, referred to as a “second threshold value”). In this case, the second threshold value may be a value less than a reception level threshold value (e.g., an SintraSearchP value and/or an SnonIntraSearchP value) in the SIB 3 of the first LTE cell 921. The electronic device 900 may determine a value that is less than the reception level threshold value (e.g., the SintraSearchP value and/or the SnonIntraSearchP value) in the SIB 3 of the first LTE cell 921 to be the second threshold value and may compare the reception level of the camp-on first LTE cell 921 with the second threshold value. When the reception level of the first LTE cell 921 is greater than the second threshold value, the electronic device 900 may not perform the cell reselection operation. When the reception level of the first LTE cell 921 is greater than the second threshold value, the processor of the electronic device 900 may control to not perform the cell reselection operation of the electronic device 900. When the reception level of the first LTE cell 921 is less than or equal to the second threshold value, the electronic device 900 may perform the cell reselection operation.

Through operation 1130, the electronic device 900 may maintain the state in which the electronic device 900 camps on the first LTE cell 921. In operation 1140, when the electronic device 900 requires a service (e.g., a 5G service or a non-5G service) for the electronic device 900, the electronic device 900 may connect to (or access) a base station (e.g., the base station 922 of FIG. 9) of the 5G shared network (e.g., the 5G cell 923) via the base station 920 of the first LTE cell 921.

For example, when the electronic device 900 receives a paging message (e.g., a paging message for the 5G service or a paging message for the non-5G service) from the base station 920 of the first LTE cell 921, the electronic device 900 may determine that the service (e.g., the 5G service or the non-5G service) for the electronic device 900 is required. When data to be transmitted (e.g., packet data), a voice call, or a text message exists, the electronic device 900 may determine that the service for the electronic device 900 is required. When the service for the electronic device 900 is required, the electronic device 900 may connect to (or access) the base station 922 building dual connectivity with the base station 920 of the first LTE cell 921. According to the connection, an RRC state of the electronic device 900 may be changed from the RRC idle state to the RRC connected state.

When the service for the electronic device 900 is not required (e.g., when a paging message is not received from the base station 920 of the first LTE cell 921 or data to be transmitted by the electronic device 900, a voice call, or a text message does not exist), the electronic device 900 may maintain the state in which the electronic device 900 camps on the first LTE cell 921.

In operation 1150, the electronic device 900 may check whether the service for the electronic device 900 corresponds to the 5G service. For example, when the electronic device 900 receives the paging message for the 5G service in operation 1140 (or when the data (e.g., packet data) to be transmitted by the electronic device 900 exists), the electronic device 900 may check the service for the electronic device 900 corresponds to the 5G service. When the electronic device 900 receives another paging message (e.g., a circuit switched (CS) paging message) in operation 1140 (or when a voice call or a text message to be transmitted by the electronic device 900 exists), the electronic device 900 may check that the service for the electronic device 900 does not correspond to the 5G service (or corresponds to the non-5G service).

When the service for the electronic device 900 corresponds to the 5G service (operation 1150—Yes), the electronic device 900 may communicate with the base station 922 of the 5G shared network (e.g., the 5G cell 923) in operation 1160. The electronic device 900 may be provided with the 5G service from the 5G shared network (e.g., the 5G cell 923).

In operation 1170, the electronic device 900 may restrict the handover operation in the RRC connected state.

According to an embodiment, in operation 1170, the electronic device 900 may block (or prohibit) an inter-RAT handover operation of the electronic device 900. The processor of the electronic device 900 may control to not perform the inter-RAT handover operation of the electronic device 900. The electronic device 900 may prevent and/or reduce inter-RAT handover even if the signal quality of an inter-RAT neighboring cell is higher than the signal quality of the first LTE cell 921 by a predetermined level or more. For example, even if the signal quality of the first LTE cell 921 is higher than the signal quality of the inter-RAT neighboring cell by a predetermined level of more, the electronic device 900 may not transmit a measurement report to the base station 920 of the first LTE cell 921.

According to an embodiment, in operation 1170, the electronic device 900 may restrictively allow inter-handover and/or intra-handover.

According to an embodiment, in operation 1170, the electronic device 900 may check whether the telecommunications carrier of the first LTE cell 921 is the same as the telecommunications carrier of the neighboring LTE cell. When the telecommunications carrier of the first LTE cell 921 is the same as the telecommunications carrier of the neighboring LTE cell of which a signal is measured, the electronic device 900 may identify whether a frequency of the neighboring LTE cell exists in a frequency list (or a frequency DB) (e.g., the frequency list (or the frequency DB) generated in operation 1050). The electronic device 900 may not perform the handover operation when the frequency of the neighboring LTE cell does not exist in the frequency list. The processor of the electronic device 900 may control to not perform the handover operation of the electronic device 900 when the frequency of the neighboring LTE cell does not exist in the frequency list. Even if the signal quality of the neighboring LTE cell is higher than the signal quality of the first LTE cell 921 by a predetermined level or more, when the frequency of the neighboring LTE cell does not exist in the frequency list, the electronic device 900 may prevent and/or reduce handover to the neighboring LTE cell.

According to an embodiment, in operation 1170, when the telecommunications carrier of the first LTE cell 921 is different from the telecommunications carrier of the neighboring LTE cell, the electronic device 900 may perform the handover operation when a reception level Srxlev of a handover condition (e.g., the cell selection condition) is less than or equal to a specific value. For example, Srxlev may be calculated to be a first reception level value (e.g., 13 dB) based on RSRP and/or RSRQ. The electronic device 600 may not perform the handover operation when Srxlev is the first reception level value (e.g., 13 dB) and may perform the handover operation when Srxlev is less than or equal to a second reception level (e.g., 10 dB).

According to an embodiment, in operation 1170, the electronic device 900 may adjust a handover parameter to restrictively perform the handover operation. For example, the electronic device 900 may lower a threshold value (e.g., the threshold value of the A2 event) for a handover event described in 3GPP TS such that the handover event (e.g., the A2 event) restrictively occurs. In another example, the electronic device 900 may raise an offset value (e.g., the A3 offset value) such that the handover event (e.g., the A3 event) restrictively occurs.

When the service for the electronic device 900 does not correspond to the 5G service (operation 1150—No), in operation 1180, the electronic device 900 may connect to the base station 910 of the first cell 911 through handover.

In operation 1190, the electronic device 900 may communicate with the base station 910 of the first cell 911.

In operation 1195, the electronic device 900 may restrict the handover operation in the RRC connected state. For example, the electronic device 900 may check whether the telecommunications carrier of the first cell 911 is the same as the telecommunications carrier of the neighboring LTE cell. When the telecommunications carrier of the first cell 911 is the same as the telecommunications carrier of the neighboring LTE cell of the first cell 911, the electronic device 900 may identify whether a frequency of the neighboring LTE cell of the first cell 911 exists in a frequency list (or a frequency DB) (e.g., the frequency list (or the frequency DB) generated in operation 1050). The electronic device 900 may not perform the handover operation when the frequency of the neighboring LTE cell of the first cell 911 does not exist in the frequency list. The processor of the electronic device 900 may control to not perform the handover operation of the electronic device 900 when the frequency of the neighboring LTE cell of the first cell 911 does not exist in the frequency list. When the telecommunications carrier of the first cell 911 is not the same as the telecommunications carrier of the neighboring LTE cell of the first cell 911, the electronic device 900 may not perform the handover operation.

In the case of the embodiment described with reference to FIG. 11A, whether to operate the electronic device 900 in the 5G shared network after RRC connection or in the first cell 911 may be determined. In the case of the embodiment described with reference to FIG. 11B, whether to operate the electronic device 900 in the 5G shared network before RRC connection or in the first cell 911 may be determined.

Referring to FIG. 11B, the electronic device 900 may perform operations 1110, 1120, 1130, 1140-1, 1150-1, 1160, 1170, 1180-1, 1190, and 1195. Operations 1110, 1120, 1130, 1160, 1170, 1190, and 1195 of FIG. 11B are the same operations as operations 1110, 1120, 1130, 1160, 1170, 1190, and 1195 of FIG. 11A, and therefore, a detailed description thereof may not be repeated here.

In operation 1140-1, the electronic device 900 may determine whether a service for the electronic device 900 corresponds to a 5G service. When the service for the electronic device 900 corresponds to the 5G service (Yes in operation 1140-1), in operation 1150-1, the electronic device 900 may connect to the base station 922 of the 5G shared network (e.g., the 5G cell 923) via the base station 920 of the first LTE cell 921. When the service for the electronic device 900 does not correspond to the 5G service (or the service for the electronic device 900 corresponds to a non-5G service) (No in operation 1140-1), in operation 1180-1, the electronic device 900 may reselect the first cell 911 and may connect to the base station 910 of the first cell 911.

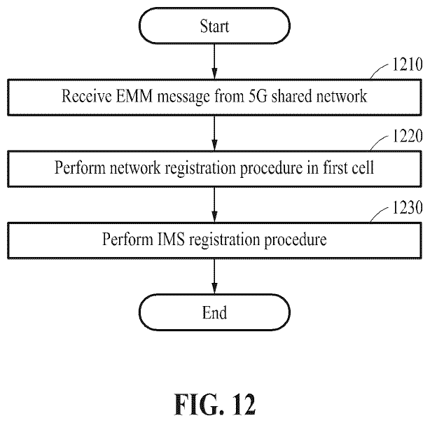

FIG. 12 is a flowchart illustrating an example operation of an electronic device when the electronic device receives an evolved packet system (EPS) mobility management (EMM) message in a 5G shared network according to various embodiments.

Referring to FIG. 12, in operation 1210, an electronic device (e.g., the electronic device 101 of FIGS. 1 to 3, the electronic device 400 of FIG. 4A, the electronic device 400-1 of FIG. 4B, the electronic device 600 of FIG. 6, and the electronic device 900 of FIG. 9) may receive an EMM message (or a network registration reject message) from a 5G shared network. The EMM message may include, for example, at least one of a TAU reject message, an attach reject message, or a service reject message, but the example is not limited thereto.

For example, the electronic device may detect a first LTE cell (e.g., the first LTE cell 921 of FIG. 9) in an RRC idle state. The electronic device may determine that a 5G cell (e.g., the 5G cell 923 of FIG. 9) of the first LTE cell 921 supports the 5G shared network based on at least a portion of system information of the detected first LTE cell 921 and system information of detected other LTE cells (e.g., the LTE cells 931 and 941 of FIG. 9). In this case, the electronic device may camp on the first LTE cell 921. The electronic device may receive the EMM message from the base station 920 of the first LTE cell 921 while the electronic device camps on the first LTE cell 921.

When the electronic device receives the EMM message, the electronic device May reselect a first cell (e.g., the first cell 911 of FIG. 9) of a network of a subscription telecommunications carrier and may camp on the first cell 911.

In operation 1220, the electronic device may perform a network registration procedure (or an attach procedure) in the camp-on first cell 911 and in operation 1230, the electronic device may perform an IMS registration (and/or RCS registration) procedure. When the electronic device camps on the network of the subscription telecommunications carrier due to TAU rejection, network registration rejection, or attach rejection in the 5G shared network, a missing call to the electronic device may occur. According to an embodiment, when the electronic device camps on the network (e.g., the first cell 911) of the subscription telecommunications carrier due to TAU rejection, network registration rejection, or attach rejection in the 5G shared network, the electronic device may perform at least one of a network registration procedure (or an attach procedure), an IMS registration procedure, or an RCS registration procedure in the first cell 911. Accordingly, a missing call to the electronic device may not occur.

Depending on the embodiment, the electronic device may not be provided with a service due to specific rejection (or a specific EMM cause) (e.g., EMM cause #15 “no suitable cells in tracking area”) in a cell of the subscription telecommunications carrier that is not the 5G shared network. In this case, the electronic device may perform at least one of the network registration procedure (or the attach procedure), the IMS registration procedure, or the RCS registration procedure.

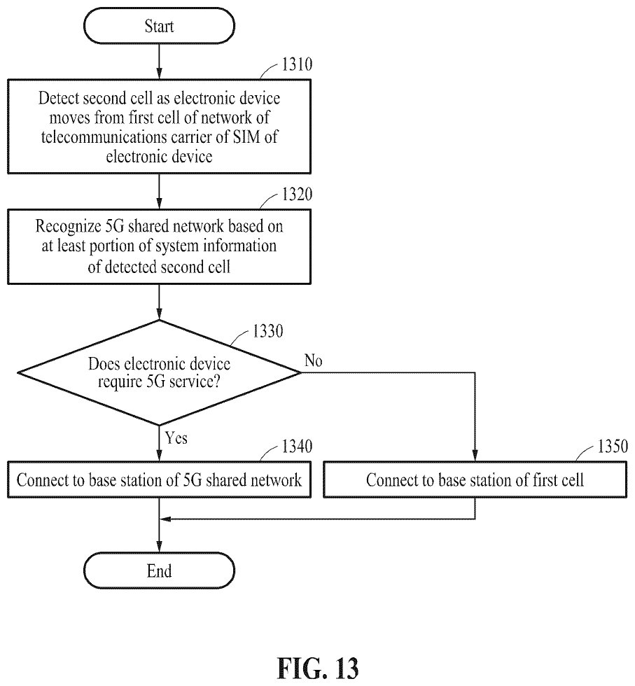

FIG. 13 is a flowchart illustrating an example method of operating an electronic device according to various embodiments.

Referring to FIG. 13, in operation 1310, an electronic device (e.g., the electronic device 101 of FIGS. 1 to 3, the electronic device 400 of FIG. 4A, the electronic device 400-1 of FIG. 4B, the electronic device 600 of FIG. 6, and the electronic device 900 of FIG. 9) may detect a second cell (e.g., the NR SA cell 621 of FIG. 6 or the first LTE cell 921 of FIG. 9) as the electronic device moves from a first cell (e.g., the first cell 611 of FIG. 6 or the first cell 911 of FIG. 9) of a network of a telecommunications carrier of a SIM (e.g., the SIM 430 of FIG. 4A or the SIMS 430-1 and 430-2 of FIG. 4B) of the electronic device. The example is not limited thereto, and the electronic device may detect the second cell in an area where the first cell and the second cell overlap each other. The electronic device may detect the second cell in a boundary area of the first cell.

In operation 1320, the electronic device may recognize the 5G shared network based on at least a portion of system information of the detected second cell.

According to an embodiment, in NR SA, the electronic device may determine whether the second cell (e.g., the NR SA cell 621 of FIG. 6) corresponds to the 5G shared network cell using at least a portion of the system information of the detected second cell (e.g., the NR SA cell 621 of FIG. 6) and system information of detected one or more other cells (e.g., the LTE cells 631 and 641).

According to an embodiment, in NR NSA, the electronic device may determine whether a 5G cell (e.g., the 5G cell 923 of FIG. 9) of the second cell (e.g., the first LTE cell 921 of FIG. 9) corresponds to the 5G shared network cell using at least a portion of the system information of the detected second cell (e.g., the first LTE cell 921 of FIG. 9) and the system information of detected one or more other cells (e.g., the LTE cells 931 and 941 of FIG. 9).

In operation 1330, the electronic device may determine whether the electronic device requires a 5G service in the 5G shared network. For example, when the electronic device recognizes that data (e.g., packet data) to be transmitted to the electronic device through a PS paging message exists or data (e.g., packet data) to be transmitted by the electronic device exists, the electronic device may determine that the electronic device requires the 5G service. When the electronic device recognizes that a voice call and/or a text message to be transmitted to the electronic device exists through another paging message (e.g., a CS paging message) or a voice call and/or a text message to be transmitted by the electronic device exists, the electronic device may determine that the electronic device requires a service other than the 5G service.

When the electronic device determines that the electronic device requires the service (e.g., a voice call and/or a text message) other than the 5G service (operation 1330—No), in operation 1350, the electronic device may connect to a base station (e.g., the base station 610 of FIG. 6 or the base station 910 of FIG. 9) of the first cell.

When the electronic device determines that the electronic device requires the 5G service (operation 1330—Yes), in operation 1340, the electronic device may connect to a base station (e.g., the base station 620 of FIG. 6 or the base station 922 of FIG. 9) of the 5G shared network.

The embodiments described with reference to FIGS. 1 to 12 may apply to a method of operating an electronic device of FIG. 13.

According to an example embodiment, the electronic device may include: a subscriber identification module (SIM) and at least one processor, comprising processing circuitry, electrically connected to the SIM. At least one processor, individually and/or collectively, may be configured to: detect a second cell based on a movement of the electronic device in a first cell of a network of a telecommunications carrier of the SIM; recognize a 5G shared network based on at least a portion of system information of the second cell; determine whether the electronic device requires a 5G service in the 5G shared network; based on determining that the electronic device requires a service other than the 5G service, control the electronic device to be connected to a base station of the first cell; and based on determining that the electronic device requires the 5G service, control the electronic device to be connected to a base station of the 5G shared network.

According to an example embodiment, at least one processor, individually and/or collectively, may be configured to: check whether a plurality of PLMN IDs is included in a SIB 1 of the second cell; based on the plurality of PLMN IDs being included in the SIB 1, compare the plurality of PLMN IDs with IDs stored in a memory; and based on checking that at least a portion of the stored ID exists in the plurality of PLMN IDs through the comparison, recognize the 5G shared network, wherein each of the stored IDs may correspond to a home network ID of a subscriber of each telecommunications carrier.

According to an example embodiment, at least one processor, individually and/or collectively may be configured to: check whether a plurality of PLMN IDs is included in the SIB 1 of the second cell, and based on the plurality of PLMN IDs being included in the SIB 1, check whether most PLMN IDs are included in the SIB 1 of the second cell among an SIB 1 of the first cell, the SIB 1 of the second cell, and respective SIB Is of detected other cells; and based on most PLMN IDs being included in the SIB 1 of the second cell and a PLMN ID in the SIB 1 of the first cell and PLMN IDs in the respective SIB Is of the detected other cells coinciding with PLMN IDs in the SIB 1 of the second cell, recognize the 5G shared network.

According to an example embodiment, The 5G shared network may be based on NR SA.

According to an example embodiment, at least one processor, individually and/or collectively, may be configured to: in the NR SA, (i) based on at least a portion of the stored IDs existing in the PLMN IDs in the SIB 1 of the second cell or (ii) based on the PLMN ID in the SIB 1 of the first cell and the PLMN IDs in the respective SIB Is of the detected other cells coinciding with at least a portion of the PLMN IDs in the SIB 1 of the second cell, check whether an upper layer indicator in an SIB 2 of a detected other LTE cell indicates a first value, and based on the upper layer indicator indicating the first value, determine that the second cell is a cell of the 5G shared network, and camp on the second cell.

According to an example embodiment, at least one processor individually and/or collectively may be configured to store a frequency of the second cell and a frequency of the detected other cell in a memory by telecommunications carriers.

According to an example embodiment, at least one processor, individually and/or collectively may be configured to: restrict a cell reselection operation to maintain a state of camping on the second cell in an RRC idle state, based on determining that the electronic device requires the service other than the 5G service, connect to a base station of the first cell, based on determining that the electronic device requires the 5G service, connect to a base station of the second cell, and restrict a handover operation in an RRC connection state connected to the base station of the second cell.

According to an example embodiment, at least one processor, individually and/or collectively, may be configured to control the electronic device to not perform inter-RAT cell reselection operation in the RRC idle state, based on a telecommunications carrier of the second cell being the same as a telecommunications carrier of a neighboring cell, determine whether a frequency of the neighboring cell exists in a frequency list stored in a memory of the electronic device, control the electronic device to not perform a cell reselection operation (e.g., the inter-frequency cell reselection operation and/or the intra-frequency cell reselection operation) based on the frequency of the neighboring cell not existing in the frequency list, and based on the telecommunications carrier of the second cell being different from the telecommunications carrier of the neighboring cell, control the electronic device to restrictively perform a cell reselection operation (e.g., the inter-frequency cell reselection operation and/or the intra-frequency cell reselection operation).

According to an example embodiment, at least one processor, individually and/or collectively, may be configured to control the electronic device to not perform inter-RAT handover operation in the RRC connected state, determine whether a telecommunications carrier of the second cell is the same as a telecommunications carrier of a neighboring cell, based on a telecommunications carrier of the second cell being the same as a telecommunications carrier of a neighboring cell, determine whether a frequency of the neighboring cell exists in a frequency list stored in a memory of the electronic device, control the electronic device to not perform a handover operation (e.g., the inter-frequency handover operation and/or the intra-frequency handover operation) based on the frequency of the neighboring cell not existing in the frequency list, and based on the telecommunications carrier of the second cell being different from the telecommunications carrier of the neighboring cell, control the electronic device to restrictively perform a handover operation (e.g., the inter-frequency handover operation and/or the intra-frequency handover operation).

According to an example embodiment, at least one processor, individually and/or collectively may be configured to, based on the electronic device being in an RRC disabled state wherein data is not transmitted or received between the electronic device and the base station of the second cell for a specified time period in the RRC connected state, restrict the cell reselection operation.

According to an example embodiment, the 5G shared network may be based on NR NSA.

According to an example embodiment, at least one processor, individually and/or collectively, may be configured to, in the NR NSA, (i) based on checking that at least a portion of the stored IDs exists in the PLMN IDs in the SIB 1 of the second cell or (ii) based on the PLMN ID in the SIB 1 of the first cell and the PLMN IDs in the respective SIB 1s of the detected other cells coinciding with at least a portion of the PLMN IDs in the SIB 1 of the second cell, check whether an upper layer indicator in an SIB 2 of the second cell indicates a second value, check whether an upper layer indicator in an SIB 2 of a detected other cell indicates the first value, determine that a 5G cell connected to the second cell is a cell of the 5G shared network through the check results, and camp on the second cell.

According to an example embodiment, at least one processor, individually and/or collectively, may be configured to store a frequency of the second cell and a frequency of the detected other cell in a memory by telecommunications carriers.

According to an example embodiment, at least one processor, individually and/or collectively, may be configured to, based on a first message including information (e.g., restrictDNCR set to false (or 0)) indicating that a use of 5G communication is not restricted in the RRC idle state being received from the base station of the second cell, restrict the cell reselection operation to maintain a camp-on state to the second cell, based on a service for the electronic device existing, connect to the base station of the 5G cell through the base station of the second cell, and restrict a handover operation in the RRC connected state of the electronic device.

According to an example embodiment, at least one processor, individually and/or collectively, may be configured to, control the electronic device to not perform an inter-RAT cell reselection operation in the RRC idle state, based on a telecommunications carrier of the second cell being the same as a telecommunications carrier of a neighboring cell, determine whether a frequency of the neighboring cell exists in a frequency list stored in a memory of the electronic device, control the electronic device to not perform a cell reselection operation (e.g., the inter-frequency cell reselection operation and/or the intra-frequency cell reselection operation) based on the frequency of the neighboring cell not existing in the frequency list, and based on the telecommunications carrier of the second cell being different from the telecommunications carrier of the neighboring cell, control to restrictively perform a cell reselection operation (e.g., the inter-frequency cell reselection operation and/or the intra-frequency cell reselection operation).

According to an example embodiment, at least one processor, individually and/or collectively, may be configured to, control the electronic device to not perform an inter-RAT handover operation in the RRC connected state, determine whether a telecommunications carrier of the second cell is the same as a telecommunications carrier of a neighboring cell, based on a telecommunications carrier of the second cell being the same as a telecommunications carrier of a neighboring cell, determine whether a frequency of the neighboring cell exists in a frequency list stored in a memory of the electronic device, control the electronic device to not perform a handover operation (e.g., the inter-frequency handover operation and/or the intra-frequency handover operation) based on the frequency of the neighboring cell not existing in the frequency list, and based on the telecommunications carrier of the second cell being different from the telecommunications carrier of the neighboring cell, control the electronic device to restrictively perform a handover operation (e.g., the inter-frequency handover operation and/or the intra-frequency handover operation).

According to an example embodiment, at least one processor, individually and/or collectively, may be further configured to, based on the service not being the 5G service, connect to the base station of the first cell through handover.

According to an example embodiment, at least one processor, individually and/or collectively, may be configured to, based on a second message including information (e.g., restrictDNCR set to true (or 1)) indicating that a use of 5G communication is restricted or a TAU reject message from the base station of the second cell, camp on the first cell.

According to an example embodiment, at least one processor, individually and/or collectively, may be configured to, based on camping on the first cell after receiving the TAU reject message, perform an IMS registration procedure.

According to an example embodiment, the electronic device may further include a different SIM (e.g., the second SIM 430-2 of FIG. 4B) electrically connected to at least one processor.

According to an example embodiment, based on the SIM corresponding to a DDS SIM in the 5G shared network being used, at least one processor, individually and/or collectively, may be configured to perform the detecting operation, the recognizing operation, the determining operation, and the controlling operation, and based on the different SIM corresponding to a non-DDS SIM in the 5G shared network being used, at least one processor, individually and/or collectively, is configured to control the electronic device to camp on the first cell.

According to an example embodiment, at least one processor, individually and/or collectively, may be configured to connect to the base station of the 5G shared network, based on the electronic device and the 5G shared network supporting VoNR, receive a VoNR call from the base station of the 5G shared network, based on the 5G shared network not supporting the VoNR, connect to the base station of the first cell through a fallback of the base station of the 5G shared network, and receive a VOLTE call from the base station of the first cell.

According to an example embodiment, the electronic device may include a plurality of SIMs, and at least one processor, comprising processing circuitry, electrically connected to each of the plurality of SIMs.

According to an example embodiment, at least one processor, individually and/or collectively may be configured to: detect a second cell based on a movement of the electronic device in a first cell wherein the second cell is detected through one of the plurality of SIMs; recognize a 5G shared network based on at least a portion of system information of the second cell; determine whether the electronic device requires a 5G service in the 5G shared network; based on determining that the electronic device requires the service other than the 5G service, control to connect to a base station of the first cell; and based on determining that the electronic device requires the 5G service; control the electronic device to connect to a base station of the 5G shared network.

According to an example embodiment, a method of operating the electronic device may include: detecting a second cell based on a movement of the electronic device in a first cell of a network of a telecommunications carrier of the electronic device; recognizing a 5G shared network based on at least a portion of system information of the second cell; determining whether the electronic device requires a 5G service in the 5G shared network; based on determining that the electronic device requires a service other than the 5G service, connecting to a base station of the first cell; and based on determining that the electronic device requires the 5G service, connecting to a base station of the 5G shared network.

While the disclosure has been illustrated and described with reference to various example embodiments, it will be understood that the various example embodiments are intended to be illustrative, not limiting. It will be further understood by those skilled in the art that various changes in form and detail may be made without departing from the true spirit and full scope of the disclosure, including the appended claims and their equivalents. It will also be understood that any of the embodiment(s) described herein may be used in conjunction with any other embodiment(s) described herein.

What is claimed is:

1. An electronic device comprising:
a subscriber identity module (SIM); and
at least one processor, comprising processing circuitry, electrically connected to the SIM,
wherein at least one processor, individually and/or collectively, is configured to: detect a second cell based on a movement of the electronic device in a first cell of a network of a telecommunications carrier of the SIM, recognize a 5G shared network based on at least a portion of system information of the second cell, determine whether the electronic device requires a 5G service in the 5G shared network, based on determining that the electronic device requires a service other than the 5G service, control the electronic device to be connected to a base station of the first cell, and based on determining that the electronic device requires the 5G service, control the electronic device to be connected to a base station of the 5G shared network.

2. The electronic device of claim 1, wherein at least one processor, individually and/or collectively, is configured to: check whether a plurality of public land mobile network (PLMN) identifiers (IDs) is included in a system information block (SIB) 1 of the second cell, based on the plurality of PLMN IDs being included in the SIB 1, compare the plurality of PLMN IDs with IDs stored in a memory, and based on determining that at least a portion of the stored ID exists in the plurality of PLMN IDs through the comparison, recognize the 5G shared network,
wherein each of the stored IDs corresponds to a home network ID of a subscriber of each telecommunications carrier.

3. The electronic device of claim 1, wherein at least one processor, individually and/or collectively, is configured to: check whether a plurality of public land mobile network (PLMN) identifiers (IDs) is included in a system information block (SIB) 1 of the second cell, based on the plurality of PLMN IDs being included in the SIB 1, check whether most PLMN IDs are included in the SIB 1 of the second cell among an SIB 1 of the first cell, the SIB 1 of the second cell, and respective SIB Is of detected other cells, and based on the most PLMN IDs being included in the SIB 1 of the second cell and a PLMN ID in the SIB 1 of the first cell and PLMN IDs in the respective SIB Is of the detected other cells coinciding with PLMN IDs in the SIB 1 of the second cell, recognize the 5G shared network.

4. The electronic device of claim 1, wherein the 5G shared network is based on new radio (NR) standalone (SA),
wherein at least one processor, individually and/or collectively, is configured to, in the NR SA, (i) based on determining that at least a portion of the stored IDs exists in the PLMN IDs in the SIB 1 of the second cell or (ii) based on the PLMN ID in the SIB 1 of the first cell and the PLMN IDs in the respective SIB Is of the detected other cells coinciding with at least a portion of the PLMN IDs in the SIB 1 of the second cell, determine whether an upper layer indicator in an SIB 2 of a detected other LTE cell indicates a first value, based on the upper layer indicator indicating the first value, determine that the second cell is a cell of the 5G shared network, and camp on the second cell.

5. The electronic device of claim 4, wherein at least one processor, individually and/or collectively, is configured to store a frequency of the second cell and a frequency of the detected other cell in a memory by telecommunications carriers.

6. The electronic device of claim 4, wherein at least one processor, individually and/or collectively, is configured to: restrict a cell reselection operation to maintain a state of camping on the second cell in a radio resource control (RRC) idle state, based on determining that the electronic device requires the service other than the 5G service, connect to a base station of the first cell, based on determining that the electronic device requires the 5G service, connect to a base station of the second cell, and restrict a handover operation in an RRC connection state connected to the base station of the second cell.

7. The electronic device of claim 6, wherein at least one processor, individually and/or collectively, is configured to: control the electronic device to not perform inter-radio access technology (RAT) cell reselection operation in the RRC idle state, based on a telecommunications carrier of the second cell being the same as a telecommunications carrier of a neighboring cell, determine whether a frequency of the neighboring cell exists in a frequency list stored in a memory of the electronic device, control the electronic device to not perform a cell reselection operation based on the frequency of the neighboring cell not existing in the frequency list, and based on the telecommunications carrier of the second cell being different from the telecommunications carrier of the neighboring cell, control the electronic device to restrictively perform a cell reselection operation.

8. The electronic device of claim 6, wherein at least one processor, individually and/or collectively, is configured to: control the electronic device to not perform inter-radio access technology (RAT) handover operation in the RRC connected state, determine whether a telecommunications carrier of the second cell is the same as a telecommunications carrier of a neighboring cell, based on a telecommunications carrier of the second cell being the same as a telecommunications carrier of a neighboring cell, determine whether a frequency of the neighboring cell exists in a frequency list stored in a memory of the electronic device, control the electronic device to not perform a handover operation based on the frequency of the neighboring cell not existing in the frequency list, and based on the telecommunications carrier of the second cell being different from the telecommunications carrier of the neighboring cell, control the electronic device to restrictively perform a handover operation.

9. The electronic device of claim 6, wherein at least one processor, individually and/or collectively, is configured to, based on the electronic device being in an RRC disabled state based on data not being transmitted or received between the electronic device and the base station of the second cell for a specified time period in the RRC connected state, restrict the cell reselection operation.

10. The electronic device of claim 1, wherein the 5G shared network is based on NR non-standalone (NSA),
wherein at least one processor is configured to, in the NR NSA, (i) based on determining that at least a portion of the stored IDs exists in the PLMN IDs in the SIB 1 of the second cell or (ii) based on the PLMN ID in the SIB 1 of the first cell and the PLMN IDs in the respective SIB Is of the detected other cells coinciding with at least a portion of the PLMN IDs in the SIB 1 of the second cell, check whether an upper layer indicator in an SIB 2 of the 20 second cell indicates a second value, check whether an upper layer indicator in an SIB 2 of a detected other cell indicates the first value, determine that a 5G cell connected to the second cell is a cell of the 5G shared network through the check results, and camp on the second cell.

11. The electronic device of claim 10, wherein at least one processor, individually and/or collectively, is configured to store a frequency of the second cell and a frequency of the detected other cell in a memory by telecommunications carriers.

12. The electronic device of claim 10, wherein at least one processor, individually and/or collectively, is configured to, based on a first message comprising information indicating that a use of 5G communication is not restricted in the RRC idle state being received from the base station of the second cell, restrict the cell reselection operation to maintain a camp-on state to the second cell, based on a service for the electronic device existing, connect to the base station of the 5G cell through the base station of the second cell, and restrict a handover operation in the RRC connected state of the electronic device.

13. The electronic device of claim 12, wherein at least one processor, individually and/or collectively is configured to, control the electronic device to not perform an inter-RAT cell reselection operation in the RRC idle state, based on a telecommunications carrier of the second cell being the same as a telecommunications carrier of a neighboring cell, determine whether a frequency of the neighboring cell exists in a frequency list stored in a memory of the electronic device, control the electronic device to not perform a cell reselection operation based on the frequency of the neighboring cell not existing in the frequency list, and based on the telecommunications carrier of the second cell being different from the telecommunications carrier of the neighboring cell, control the electronic device to restrictively perform a cell reselection operation.

14. The electronic device of claim 12, wherein at least one processor, individually and/or collectively, is configured to, control the electronic device to not perform an inter-radio access technology (RAT) handover operation in the RRC connected state, determine whether a telecommunications carrier of the second cell is the same as a telecommunications carrier of a neighboring cell, based on a telecommunications carrier of the second cell being the same as a telecommunications carrier of a neighboring cell, determine whether a frequency of the neighboring cell exists in a frequency list stored in a memory of the electronic device, control the electronic device to not perform a handover operation based on the frequency of the neighboring cell not existing in the frequency list, and based on the telecommunications carrier of the second cell being different from the telecommunications carrier of the neighboring cell, control the electronic device to restrictively perform a handover operation.

15. The electronic device of claim 12, wherein at least one processor, individually and/or collectively, is configured to, based on the service not being the 5G service, connect to the base station of the first cell through handover.

16. The electronic device of claim 12, wherein at least one processor, individually and/or collectively, is configured to, based on a second message including information indicating that a use of 5G communication is restricted or a tracking area update (TAU) reject message from the base station of the second cell, camp on the first cell.

17. The electronic device of claim 16, wherein at least one processor, individually and/or collectively, is configured to, based on camping on the first cell after receiving the TAU reject message, perform an IP multimedia subsystem (IMS) registration procedure.

18. The electronic device of claim 1, further comprising:
a different SIM electrically connected to at least one processor,
wherein, based on the SIM corresponding to a default data subscription (DDS) SIM in the 5G shared network being used, at least one processor, individually and/or collectively, is configured to perform the detecting operation, the recognizing operation, the determining operation, and the controlling operation, and based on the different SIM corresponding to a non-DDS SIM in the 5G shared network being used, at least one processor, individually and/or collectively, is configured to control the electronic device to camp on the first cell.

19. The electronic device of claim 1, wherein at least one processor, individually and/or collectively, is configured to connect to the base station of the 5G shared network, based on the electronic device and the 5G shared network supporting voice over new radio (VoNR), receive a VoNR call from the base station of the 5G shared network, based on the 5G shared network not supporting the VoNR, connect to the base station of the first cell through a fallback of the base station of the 5G shared network, and receive a voice over long-term evolution (VOLTE) call from the base station of the first cell.

20. An electronic device, comprising:
a plurality of subscriber identity modules (SIMs); and
at least one processor, comprising processing circuitry, electrically connected to each of the plurality of SIMs,
wherein at least one processor, individually and/or collectively, is configured to: detect a second cell through one of the plurality of SIMs based on a movement of the electronic device in a first cell, recognize a 5G shared network based on at least a portion of system information of the second cell, determine whether the electronic device requires a 5G service in the 5G shared network, based on determining that the electronic device requires the service other than the 5G service, control the electronic device to connect to a base station of the first cell, and based on determining that the electronic device requires the 5G service, control the electronic device to connect to a base station of the 5G shared network.
